(19) United States
(12) Patent Application Publication
(10) Pub. No.: US 2009/0219653 A1
(43) Pub. Date: Sep. 3, 2009

(54) HEAD SLIDER EQUIPPED WITH PIEZOELECTRIC ELEMENT

(75) Inventors: Tsuyoshi Aoki, Kawasaki (JP); Kazuaki Kurihara, Kawasaki (JP); Shigeyoshi Umemiya, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/395,161

(22) Filed: Feb. 27, 2009

(30) Foreign Application Priority Data
Feb. 29, 2008 (JP) 2008-048921
Nov. 26, 2008 (JP) 2008-300547

(51) Int. Cl. G11B 5/56; B05D 5/12

(52) U.S. Cl. 360/294.4; 427/532

(57) ABSTRACT

A head slider includes a slider substrate, an actuator provided in an end portion of the slider substrate and equipped with a piezoelectric element, and a magnetic head disposed on a side opposite to the slider substrate with interposition of the actuator. The piezoelectric element has piezoelectric bodies polarized along a first direction connecting the slider substrate and the magnetic head. The piezoelectric element has electrodes which apply an electric field to the piezoelectric bodies along a second direction intersecting the first direction.

### CROSS REFERENCE TO RELATED APPLICATIONS

This application is based upon and claims the benefit of priorities of prior Japanese Patent Applications No. 2008-048921 filed on Feb. 29, 2008 and No. 2008-300547 filed on Nov. 26, 2008, the entire contents of which are incorporated herein by references.

### FIELD

The present invention relates to a head slider used in a hard disk drive, the hard disk drive and a method for manufacturing the head slider.

### BACKGROUND

In a hard disk drive (HDD), the track pitch in a magnetic disk has been narrowed with the increase in capacity of recording data at a very high rate based on technical improvements in the magnetic disk, a magnetic head, signal processing, etc. in the HDD. In such a situation, a gap between the head slider and the magnetic disk, i.e. a floating quantity of the magnetic head relative to a front surface of the magnetic disk, has become very small. For this reason, there is a demand for control of the floating quantity with high accuracy and at a high speed.

As a method for adjusting the floating quantity of a magnetic head with high accuracy, there has been known a technique in which a heater is mounted in the inside of a head slider so that a floating surface of the head slider is protrudes by thermal expansion of the heater. On the other hand, there has been also known a technique in which a piezoelectric element is mounted in a head slider so that the position of a magnetic head is displaced by use of the displacement of the piezoelectric element.

The technique of mounting a heater in the inside of a head slider has a problem that response speed is low because the technique uses a phenomenon that the heater expands thermally. The other technique has a problem that it is difficult to manufacture head sliders with uniform response characteristics because the piezoelectric element must be stuck to a slider substrate in manufacturing.

### SUMMARY

According to one aspect of the invention, a head slider includes a slider substrate, an actuator provided in an end portion of the slider substrate and equipped with a piezoelectric element, and a magnetic head disposed on a side opposite to the slider substrate with interposition of the actuator. The piezoelectric element has piezoelectric bodies polarized along a first direction connecting the slider substrate and the magnetic head. The piezoelectric element has electrodes which apply an electric field to the piezoelectric bodies along a second direction intersecting the first direction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a view showing a schematic structure of a hard disk drive according to Embodiment 1;

FIG. 2 is a view showing schematic blocks of a control circuit portion according to Embodiment 1;

FIGS. 3A and 3B are views showing a magnetic head support according to Embodiment 1;

FIG. 4 is a perspective view showing a schematic structure of a head slider according to Embodiment 1;

FIG. 5 is a perspective view showing a schematic structure of an actuator according to Embodiment 1;

FIGS. 6A to 6I are views showing respective manufacturing steps of the head slider according to Embodiment 1;

FIG. 7 is a typical view showing a displacement state of a head portion according to Embodiment 1;

FIG. 8 shows a result of simulation by which displacement of the actuator according to Embodiment 1 is confirmed;

FIG. 9 is a schematic sectional view showing a head slider according to Embodiment 2;

FIGS. 10A to 10E are views showing respective manufacturing steps of the head slider according to Embodiment 2;

FIG. 11 is a view showing a condition used when simulation is performed for an actuator according to Embodiment 2;

FIG. 12 shows a result (part 1) of simulation by which displacement of the actuator according to Embodiment 2 is confirmed;

FIG. 13 shows a result (part 2) of simulation by which displacement of the actuator according to Embodiment 2 is confirmed;

FIG. 14 shows a result (part 3) of simulation by which displacement of the actuator according to Embodiment 2 is confirmed;

FIG. 15 is a schematic sectional view showing a head slider according to Embodiment 3;

FIGS. 16A to 16H are views showing respective manufacturing steps of the head slider according to Embodiment 3;

FIG. 17 is a schematic sectional view showing a head slider according to Embodiment 4;

FIG. 18 is a perspective view showing a schematic structure of an actuator according to Embodiment 4;

FIGS. 19A to 19G are views showing respective manufacturing steps of the head slider according to Embodiment 4;

FIG. 20 is a perspective view showing a schematic structure of an actuator according to Embodiment 5; and

FIGS. 21A to 21G are views showing respective manufacturing steps of a head slider according to Embodiment 5.

### DETAILED DESCRIPTION OF THE EMBODIMENTS

Embodiments of the invention will be described below in detail with reference to the drawings. Incidentally, the embodiments are simply exemplified and the invention is not necessarily limited to the configurations shown in the embodiments.

### Embodiment 1

### Hard Disk Drive

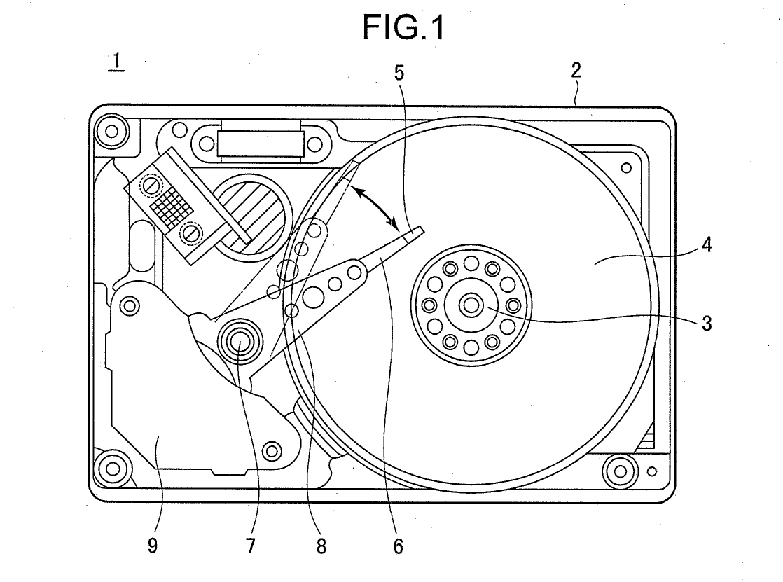

A hard disk drive 1 shown in FIG. 1 has a housing 2 as its exterior illustrates in FIG. 1. A magnetic disk 4 and a head slider 5 are provided in the inside of the housing 2. The magnetic disk 4 is mounted on a rotary shaft 3 so that the magnetic disk 4 can rotate on the rotary shaft 3. The head slider 5 is equipped with a magnetic head which records/reproduces information on/from the magnetic disk 4. A suspension 6, a carriage arm 8, an electromagnetic actuator 9, etc. are further provided in the inside of the housing 2. The suspension 6 holds the head slider 5. The carriage arm 8 moves the suspension 6 along a front surface of the magnetic disk 4 so that the suspension 6 pivots on an arm shaft 7. The electromagnetic actuator 9 drives the carriage arm 8. A cover (not shown) is attached to the housing 2, so that the aforementioned constituent parts are disposed in an internal space formed by the housing 2 and the cover.

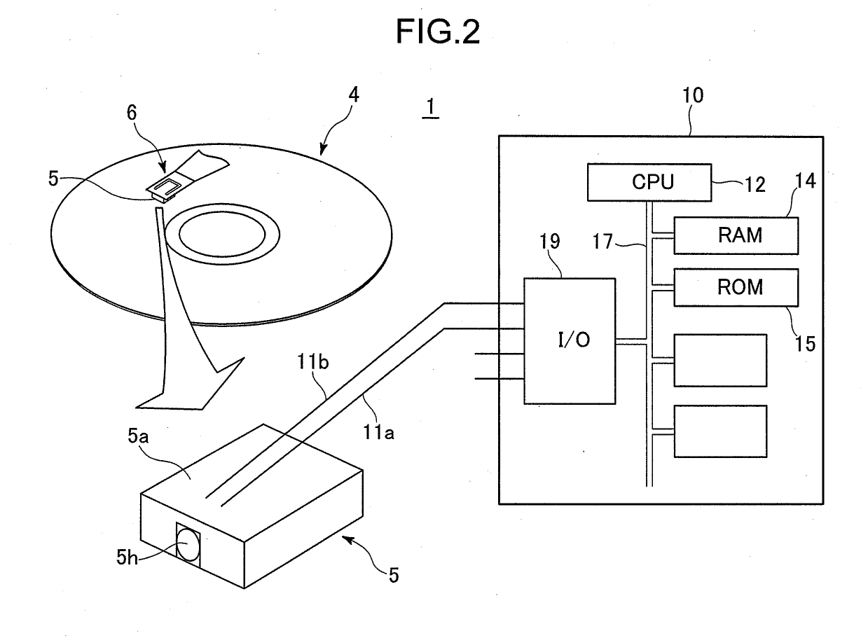

As shown in FIG. 2, the hard disk drive 1 further has a control circuit portion 10 which controls operation of the hard disk drive 1. For example, the control circuit portion 10 is mounted on a control board (not shown) provided in the inside of the housing 2. As shown in FIG. 2, the control circuit portion 10 has a CPU (Central Processing Unit) 12, a RAM (Random Access Memory) 14, a ROM (Read Only Memory) 15, an I/O circuit 19, and a bus 17 or the like. The RAM 14 temporarily stores data etc. processed by the CPU 12. The ROM 15 stores a control program etc. The I/O circuit 19 performs input/output of a signal from/to the outside. Signals are transmitted among these circuits by the bus 17.

As shown in FIG. 2, the slider 5 has a ceramic substrate 5a, and a magnetic head 5h formed in the ceramic substrate 5a. For example, the magnetic head 5h is connected to the I/O circuit 19 in the control circuit portion 10 by wires 11a and 11b so that the magnetic head 5h performs recording (write operation) of information on the magnetic disk 4 and reproduction (read operation) of information stored in the magnetic disk 4. For the read or write operation, the carriage arm 8 is driven by the electromagnetic actuator 9 to move the magnetic head 5h to a desired track on the magnetic disk 4.

### —Magnetic Head Support—

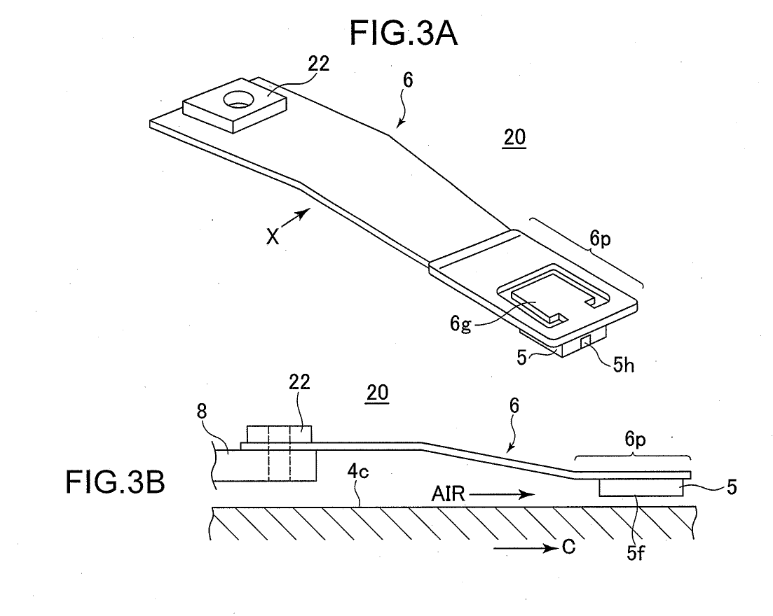

An example of a magnetic head support according to this embodiment will be described with reference to FIGS. 3A and 3B. Incidentally, the magnetic head support is also called HGA (Head Gimbal Assembly). FIGS. 3A and 3B are views showing the magnetic head support according to Embodiment 1. FIG. 3A is a perspective view of the magnetic head support. FIG. 3B is a side view of the magnetic head support (in an X direction shown in FIG. 3A).

As shown in FIGS. 3A and 3B, the magnetic head support 20 generally means a structure after a base plate 22 and the head slider 5 or the like are attached to the suspension 6. However, the magnetic head support 20 sometimes means a state before the base plate 22 and the head slider 5 are attached to the suspension 6, i.e. the magnetic head support 20 may mean only the suspension 6. Further, the magnetic head support 20 sometimes means a structure after either of the base plate 22 and the head slider 5 is attached to the suspension 6. Here, for example, the suspension 6 is a plate-like member of stainless steel 20 μm thick. The base plate 22 is joined to one end of the suspension 6 on the carriage arm 8 side while the head slider 5 is attached to the other end (tip portion 6p) of the suspension 6. More specifically, for example, the head slider 5 is fixed to a gimbal 6g provided in the tip portion 6p of the suspension 6. Incidentally, the head slider 5 is disposed in a position opposite to a front surface 4c of the magnetic disk.

As shown in FIG. 3B, when the magnetic disk rotates in a direction of a arrow C, air flows into a gap under a floating surface 5f of the head slider 5 from a direction of a arrow “Air” in FIG. 3B. The flow of air produces a buoyant force in the head slider 5, so that the head slider 5 floats up from the front surface 4c of the magnetic disk 4.

### —Head Slider —

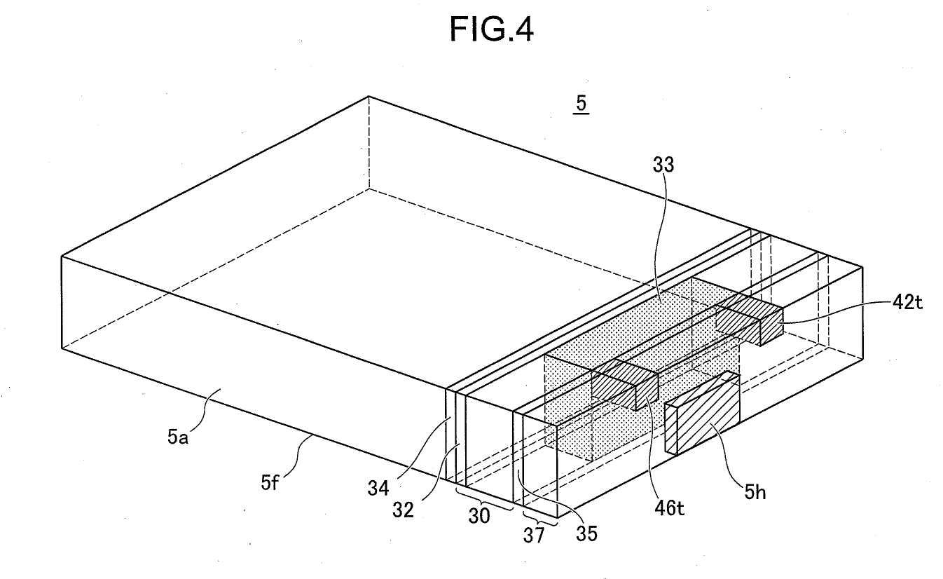

FIG. 4 is a perspective view showing a schematic structure of the head slider 5 in Embodiment 1. As shown in FIG. 4, an actuator 33 is disposed in an end portion of a ceramic substrate (slider substrate) 5a. A head portion 37 having a magnetic head 5h formed therein is disposed on a side opposite to the ceramic substrate 5a with interposition of the actuator 33. That is, the magnetic head 5h is located on a side opposite to the ceramic substrate 5a with interposition of the actuator 33. As shown in FIG. 4, for example, external terminals 42t and 46t for applying a voltage to the actuator 33 are provided in the head portion 37. For example, the ceramic substrate 5a is made of an AlTiC(Al₂O₃—TiC) material. The AlTiC material is one kind of ceramic. Specifically, the AlTiC material is a sintered material of alumina (Al₂O₃) and titanium carbide (TiC).

An insulating layer 34 for electrically insulating the ceramic substrate 5a and the actuator 33 from each other is provided between the ceramic substrate 5a and the actuator 33. For example, the insulating layer 34 is a film of an insulating material with a thick of 500 nm. As shown in FIG. 4, the insulating layer 34 is formed on an end surface of the ceramic substrate 5a. Examples of the material allowed to be used as the insulating layer 34 include alumina (Al₂O₃), and titanium oxide (TiO₂). When such an insulating layer 34 is provided, the ceramic substrate 5a can be completely insulated from electrodes of the actuator 33 to prevent electric noise on the actuator 33 side from leaking to the ceramic substrate 5a.

Incidentally, the insulating layer 34 provided between the ceramic substrate 5a and the actuator 33 may be replaced by a conducting layer 34D (not shown) provided in the position of the insulating layer 34 shown in FIG. 4. Examples of the material allowed to be used as the conducting layer 34D are metals such as platinum (Pt), iridium (Ir), etc. Further examples of the material allowed to be used as the conducting layer 34D are conductive nitrides such as titanium nitride (TiN), etc. and conductive oxides such as indium tin oxide (ITO), etc. In this case, a voltage supply terminal (not shown) is provided in the ceramic substrate 5a so that a GND potential from the control circuit portion 10 can be given to a voltage supply portion 43 via the ceramic substrate 5a. In this case, the GND potential is grounded via the ceramic substrate 5a (at a position near the head slider 5) so that the GND potential can be stabilized easily.

An insulating layer 35 is provided between the actuator 33 and the head portion 37 so that the actuator 33 and the head portion 37 can be electrically insulated from each other by the insulating layer 35. For example, the insulating layer 35 is a film of an insulating material with a thick of 500 nm. Examples of the material allowed to be used as the insulating layer 35 are alumina (Al₂O₃), titanium oxide (TiO₂), etc. Incidentally, a portion where the actuator 33 is disposed between the insulating layer 34 and the insulating layer 35 is referred to as displacement portion 30. The shape of the displacement portion 30 is deformed in accordance with distortion of the actuator 33. A lower electrode 32 and the actuator 33 are provided in the displacement portion 30. The lower electrode 32 will be described later.

### —Actuator—

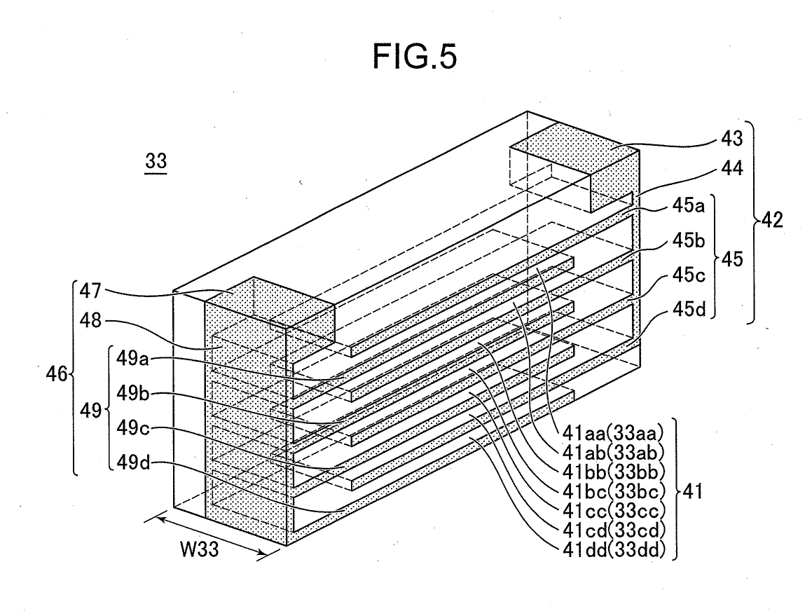

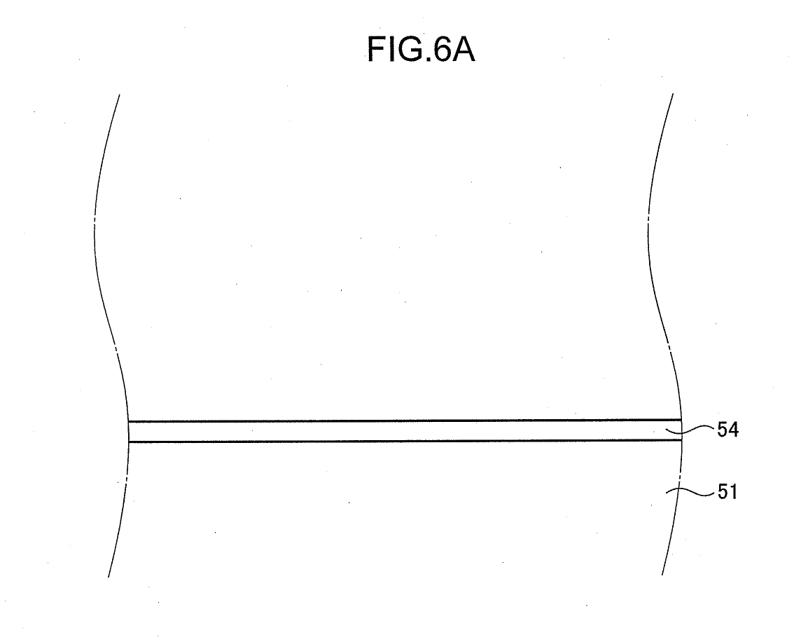

As shown in FIG. 5, for example, the actuator 33 has a piezoelectric body 41, and two electrodes. The piezoelectric body 41 is made of a piezoelectric material. The two electrodes are a minus-side electrode 42 and a plus-side electrode 46. As shown in FIG. 5, piezoelectric body layers 41aa to 41dd, each of which is a part of the piezoelectric body 41, are wedged between branch portions 45 (45a to 45d) of the minus-side electrode 42 and branch portions 49 (49a to 49d) of the plus-side electrode 46, respectively. For example, the film thickness of each of these branch portions 45a to 45d and 49a to 49d is about 2-5 μm.

Here, it is preferable that the electrode pattern of the actuator 33 is formed so as to range from the floating surface 5f of the head slider 5 to an opposite surface thereof. When the electrode pattern of the actuator 33 is formed widely in the head slider 5 in this manner, a shear actuating force of the actuator 33 is produced on the whole area of a process surface of the head slider 5 so that the head portion 37 can move in parallel smoothly.

Examples of the piezoelectric material allowed to be used as the piezoelectric body 41 are ferroelectric materials such as lead zirconate titanate PZT (Pb(Zr,Ti)O₃), lead lanthanum zirconate titanate PLZT ((Pb,La)(Zr,Ti)O₃), etc. Besides these materials, potassium niobate (KNbO₃) can be used. Further, a substance containing PZT and Nb added to PZT can be used.

Examples of the material allowed to be used as the minus-side electrode 42 and the plus-side electrode 46 are conductive materials such as copper (Cu), gold (Au), platinum (Pt), iridium (Ir), etc. Among these materials, copper (Cu) and gold (Au) are particularly preferred because copper (Cu) and gold (Au) can be easily applied to plating.

As shown in FIG. 5, the minus-side electrode 42 is made up of three parts, i.e. the voltage supply portion 43, a base portion 44 and the branch portions 45. The voltage supply portion 43 is a portion which is supplied with, for example, a minus-side potential (0V in the control circuit portion 10) from the control circuit portion 10 and which is located on a side opposite to the floating surface 5f of the head slider 5. The base portion 44 extends from one part of the voltage supply portion 43 toward the floating surface 5f. The branch portions 45 (45a to 45d) branch from the base portion 44. All of these branch portions 45a to 45d extend in parallel with the floating surface. That is, each branch portion 45 is a plate-like wiring pattern extending along the floating surface 5f. Incidentally, this plate-like wiring pattern has upper and lower principle surfaces along the floating surface 5f, and a thickness decided by the distance between of the upper and lower principle surfaces.

On the other hand, the plus-side electrode 46 is made up of three parts, i.e. a voltage supply portion 47, a base portion 48 and the branch portions 49, similarly to the minus-side electrode 42. The voltage supply portion 47 is a portion which is supplied with, for example, a plus-side potential from the control circuit portion 10 and which is located on a side opposite to the floating surface 5f of the head slider 5. The base portion 48 extends from one part of the voltage supply portion 47 toward the floating surface 5f. The branch portions 49 (49a to 49d) branch from the base portion 48. All of these branch portions 49a to 49d extend in parallel with the floating surface 5f. That is, each branch portion 49 is a plate-like wiring pattern extending in parallel with the floating surface 5f.

The external terminals 42t and 46t shown in FIG. 4 are connected to the voltage supply portions 43 and 47, respectively, so that the potentials from the control circuit portion 10 are supplied to the voltage supply portions 43 and 47 through the external terminals 42t and 46t, respectively. The potentials from the control circuit portion 10 are given to the external terminals 42t and 46t via the wires 11a and 11b, respectively.

The branch portions 45a to 45d of the minus-side electrode 42 and the branch portions 49a to 49d of the plus-side electrode 46 are disposed alternately as shown in FIG. 5. The branch portions 45a to 45d and 49a to 49d and the piezoelectric body films 41aa to 41dd wedged between the branch portions 45a to 45d and 49a to 49d form piezoelectric elements 33aa to 33dd, respectively. That is, the actuator 33 has a structure in which the piezoelectric elements 33aa to 33dd are laminated continuously. Although Embodiment 1 shows an example of a structure in which seven piezoelectric elements 33aa to 33dd are laminated, the invention is effective if at least one piezoelectric element is provided. For example, each of the piezoelectric body films 41aa to 41dd is 2-5 μm thick and 3-4 μm wide in a W33 direction. Incidentally, the width of W33 in FIG. 5 is, for example, 5 μm. Since each of the piezoelectric elements 33aa to 33dd has a constant distortion force, a larger displacement quantity can be expected to be obtained as the number of piezoelectric elements increases until the number of piezoelectric elements reaches a predetermined value (upper limit).

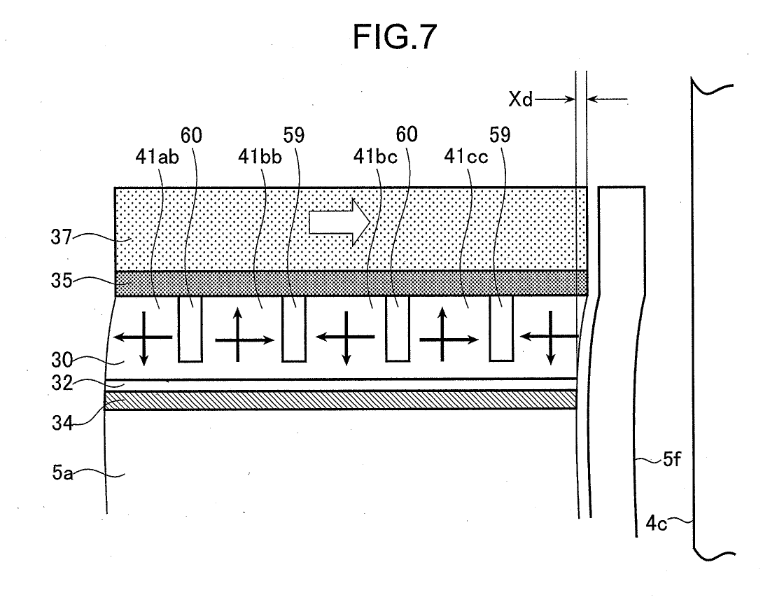

Adjacent ones of the piezoelectric body films 41aa to 41dd are polarized in directions opposite to each other (see FIG. 7). Specifically, the piezoelectric body films 41aa, 41bb, 41cc and 41dd are polarized in a direction from the ceramic substrate 5a toward the head portion 37. The piezoelectric body films 41ab, 41bc and 41cd are polarized in a direction from the head portion 37 toward the ceramic substrate 5a. That is, each piezoelectric body film is polarized along a direction (first direction) which connects the ceramic substrate 5a and the head portion 37.

When voltages are applied to these electrodes (the branch portions 45 and the branch portions 49), electric fields which are directed to the piezoelectric body in opposite directions are produced alternately in the piezoelectric body films 41aa to 41dd because the branch portions 45 and the branch portions 49 are disposed alternately. For example, an electric field in a direction from the surface opposite to the floating surface 5f toward the floating surface 5f is applied to each of the piezoelectric body films 41aa, 41bb, 41cc and 41dd whereas an electric field in a direction from the floating surface 5f toward the surface opposite to the floating surface 5f is applied to each of the piezoelectric body films 41ab, 41bc and 41cd. That is, the electric fields are applied to the respective piezoelectric body films along a second direction which intersects the first direction.

When such electric fields are applied, all the piezoelectric elements 33aa to 33dd are distorted in the same direction. Distortion of the piezoelectric elements 33aa to 33dd on this occasion is d15 shear strain. It is preferable that the second direction is perpendicular to the first direction in order to make the applied electric fields act on the piezoelectric body films more effectively to obtain distortion in such a direction. In addition, it is preferable that the second direction is perpendicular to the floating surface 5f of the head slider 5.

As described above, in accordance with Embodiment 1, the piezoelectric elements 33aa to 33dd can be distorted by d15 shear strain in a direction perpendicular to the direction from the ceramic substrate 5a toward the magnetic head 5h (head portion 37), i.e. in a direction of changing the floating quantity of the magnetic head 5h. Incidentally, d15 shear strain is larger in piezoelectric constant than d31 strain or d33 strain. In addition, because d15 shear strain depends on the aspect ratio, d15 shear strain can provide a large displacement quantity in the direction of changing the floating quantity of the magnetic head 5h when the aspect ratio is made high.

### —Head Slider Manufacturing Process—

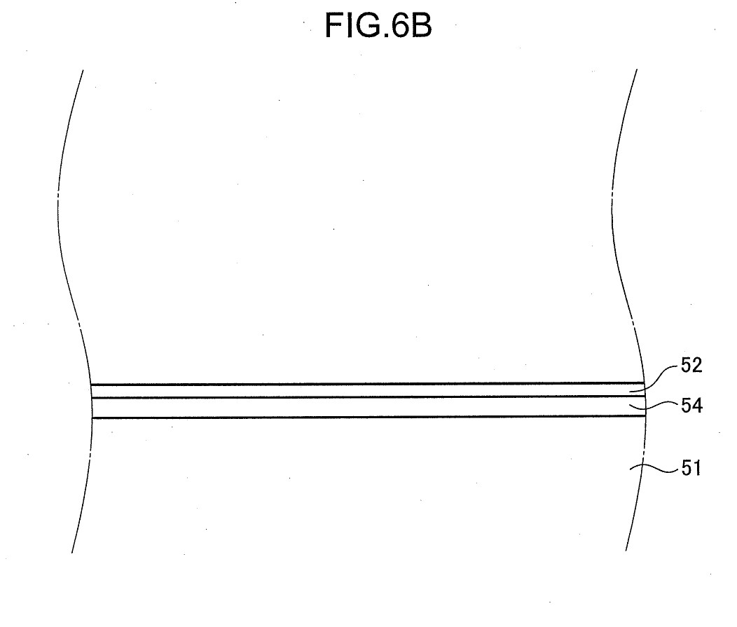

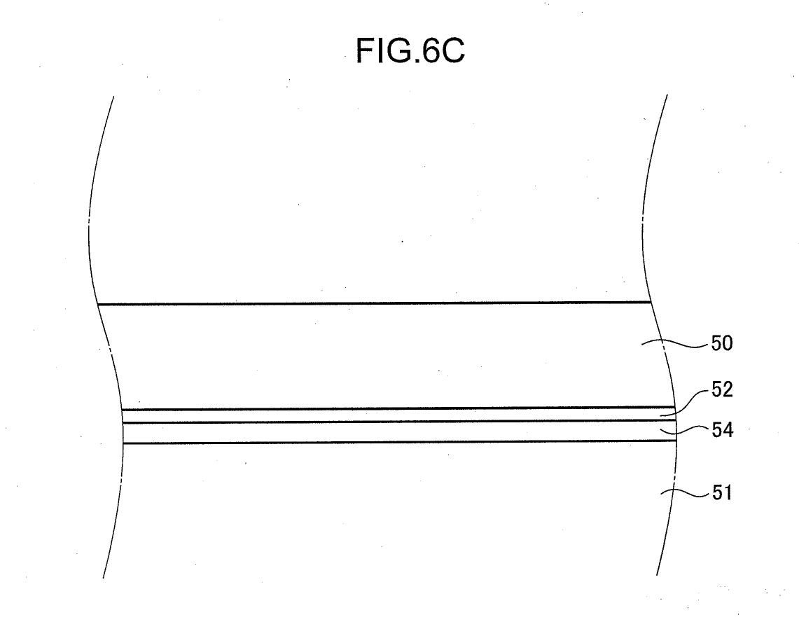

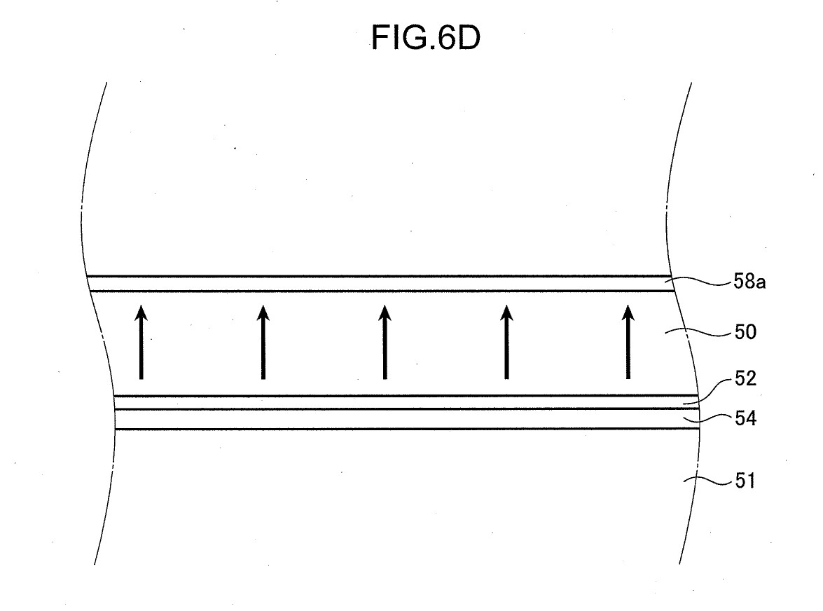

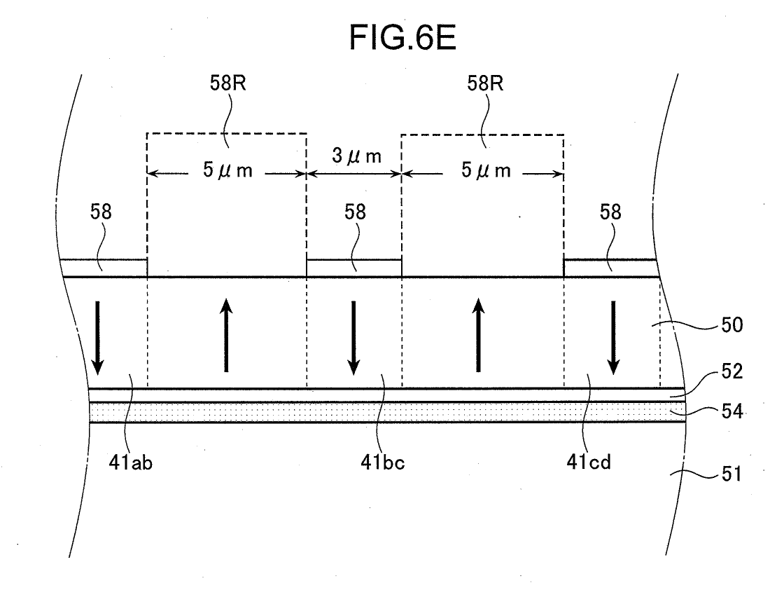

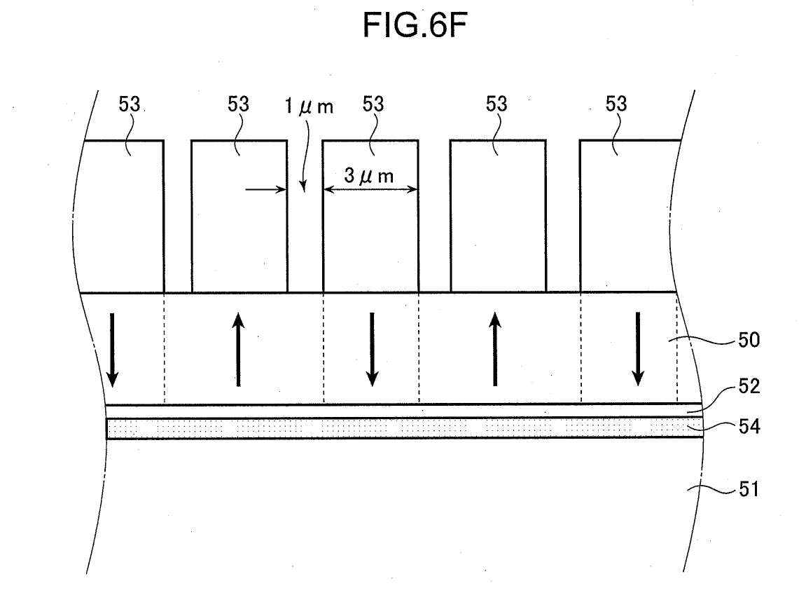

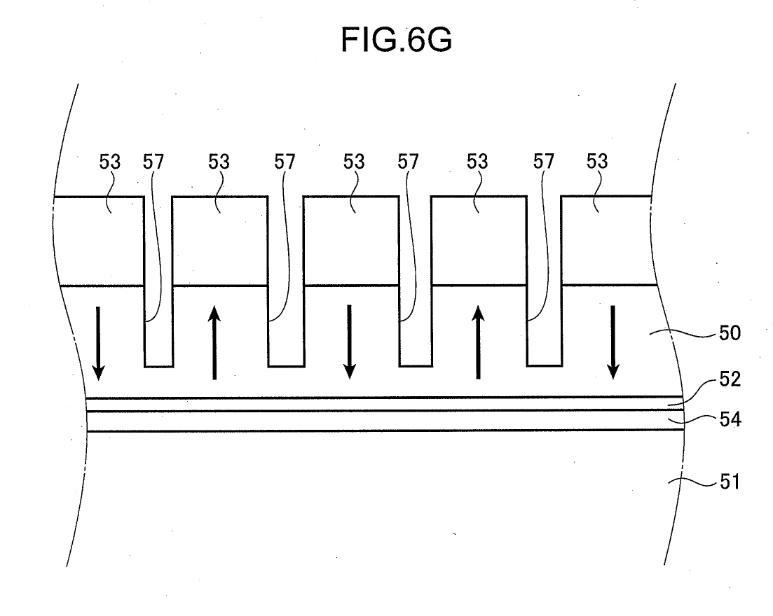

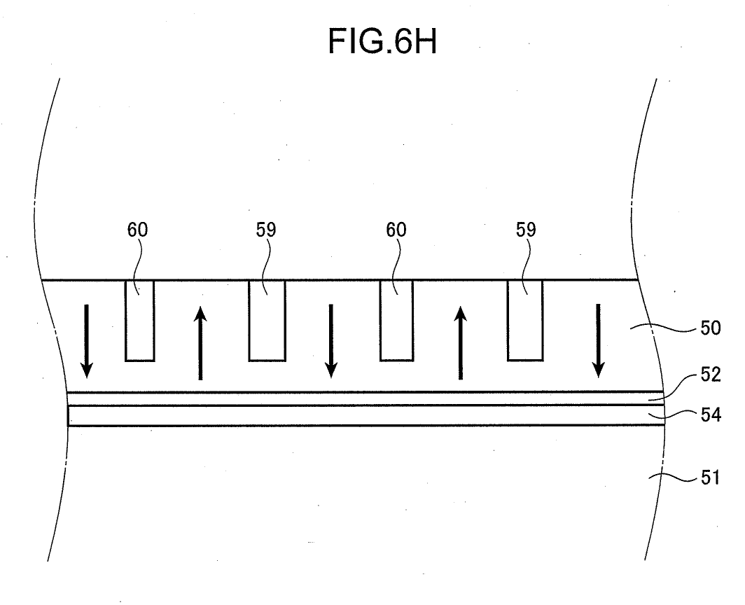

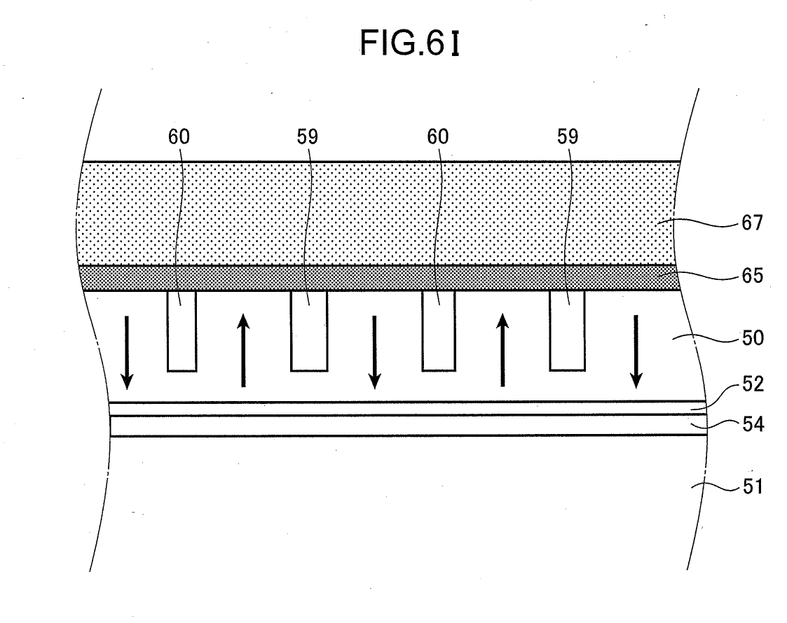

A process for manufacturing the head slider 5 in Embodiment 1 will be described below with reference to FIGS. 6A to 6I.

### <Step 1>

In this step, as shown in FIG. 6A, an insulating material film 54 is first formed on one surface of an AlTiC(Al₂O₃—TiC) substrate 51.

Specifically, for example, a wafer-shaped AlTiC substrate 51 is prepared. This AlTiC substrate 51 will be provided as a ceramic substrate 5a (slider substrate) of a head slider 5 after completion of the whole manufacturing process. Then, for example, alumina (Al₂O₃) or titanium oxide (TiO₂) is deposited on a front surface of the AlTiC substrate 51 by sputtering to thereby form an insulating material film 54 with a thick of about 500 nm. This insulating material film 54 will be provided as an insulating film 34 after completion of the whole manufacturing process.

Incidentally, for formation of a conducting layer 34D in place of the insulating layer 34, for example, platinum (Pt) or iridium (Ir) is deposited on the front surface of the AlTiC substrate 51 by sputtering to thereby form a conducting material film (not shown) with a thick of about 500 nm.

### <Step 2>

Then, as shown in FIG. 6B, a lower electrode layer 52 is formed on the insulating material film 54 (or the conducting material film 54D). The lower electrode layer 52 is a layer for forming the lower electrode 32 and is formed above the AlTiC substrate 51.

Specifically, platinum (Pt) or iridium (Ir) is deposited on a front surface of the insulating material film 54 by sputtering or vacuum vapor deposition to thereby form a lower electrode layer 52 with a thick of about 200 nm. Incidentally, a conductive nitride such as titanium nitride (TiN) or a conductive oxide such as indium tin oxide (ITO) may be used as the material of the lower electrode layer 52.

### <Step 3>

Then, a piezoelectric body layer 50 containing a piezoelectric material as a main material or made of a piezoelectric material is formed on the lower electrode layer 52 as shown in FIG. 6C. This piezoelectric body layer 50 is a layer for forming a piezoelectric body 41.

Specifically, a piezoelectric material is deposited on a front surface of the lower electrode layer 52 by sputtering to thereby form a piezoelectric body layer 50 about 5 μm thick. Besides sputtering, for example, sol-gel processing, pulsed laser vapor deposition, metal organic chemical vapor deposition (MOCVD) or aerosol deposition may be used on this occasion. Examples of the piezoelectric material allowed to be used here are ferroelectric materials such as lead zirconate titanate PZT (Pb(Zr,Ti)O₃), lead lanthanum zirconate titanate PLZT ((Pb,La)(Zr,Ti)O₃), etc. Besides these ferroelectric materials, potassium niobate (KNbO₃) may be used. Further, a substance containing PZT and Nb added to PZT may be used. When Nb is added to PZT in this manner, the Curie temperature of PZT can be increased to prevent the polarized state of PZT from changing in heat treatment such as anneal after a polarization process. Incidentally, heat treatment at about 300° C. is generally performed as annealing in a post process for forming the magnetic head 5h. It is preferable that the Curie temperature is set at 300° C. or higher so that the polarized state can be kept even when the piezoelectric body layer 50 is heated by such heat treatment.

### <Step 4>

Then, as shown in FIG. 6D, a polarizing process is applied to the whole of the piezoelectric body layer 50.

Specifically, for example, aluminum (Al) is first deposited on a front surface of the piezoelectric body layer 50 by sputtering or vacuum vapor deposition to thereby form an upper electrode layer 58a with a thick of about 200 nm. On this occasion, the upper electrode layer 58a is formed on the whole surface of the piezoelectric body layer 50.

Then, a voltage is applied between the lower electrode layer 52 and the upper electrode layer 58a. For example, 0V is applied to the lower electrode layer 52 while a voltage of 100V is applied to the upper electrode layer 58a. When an electric field is applied to the whole film in this manner, directions of polarization of the piezoelectric material in the piezoelectric body layer 50 are made parallel with one direction. Incidentally, the direction of polarization on this occasion is a direction from the lower electrode layer 52 toward the upper electrode layer 58a, i.e. a direction from the AlTiC substrate 51 toward the head portion 37.

Finally, the upper electrode layer 58a is removed by wet etching using phosphoric acid (H₃PO₄).

### <Step 5>

Then, as shown in FIG. 6E, a polarizing process for polarization in a direction opposite to the direction in the previous step is applied to part of the piezoelectric body layer 50.

Specifically, a striped resist pattern 58R is formed on the front surface of the piezoelectric body layer 50. For example, as shown in FIG. 6E, the resist pattern 58R is a striped pattern with a line width of 5 μm and a line interval of 3 μm. Incidentally, the region where the resist pattern 58R is formed corresponds to a region other than the region where the piezoelectric body films 41ab, 41bc and 41cd will be formed.

Then, an aluminum film is formed again. Specifically, aluminum is deposited on the front surface of the piezoelectric body film 50 with the resist pattern 58R by sputtering or vacuum vapor deposition. Then, the resist pattern 58R is removed and local electrodes 58, for example, about 200 nm-thick electrodes are formed by lift-off. On this occasion, as shown in FIG. 6E, the local electrodes 58 are formed on the striped region with a line width of 3 μm and a line interval of 5 μm.

Then, 0V is applied to the lower electrode layer 52 while a voltage of minus 100V is applied to the local electrodes 58. When an electric field is applied in this manner, the region where the local electrodes 58 are formed, i.e. the region where the piezoelectric body films 41ab, 41bc and 41cd will be formed is polarized in a direction from the local electrodes 58 toward the lower electrode layer 52, i.e. in a direction from the head portion 37 toward the AlTiC substrate 51 (ceramic substrate 5a). In this manner, directions of polarization of adjacent ones of the piezoelectric body films formed in the piezoelectric body layer 50 are made substantially parallel to each other and reversed alternately.

Finally, the local electrodes 58 are removed by wet etching using phosphoric acid (H₃PO₄).

### <Step 6>

Then, as shown in FIG. 6F, a resist pattern 53 is formed.

Specifically, a resist film 53a (not shown) is formed on the whole of the front surface of the piezoelectric body layer 50 and patterned by photolithography into such a form that only the region where the piezoelectric body films 41aa to 41dd will be formed is left. Incidentally, this patterning is performed by an ultraviolet light exposure device such as an i-beam exposure device, an exposure device using a krypton fluoride (KrF) or argon fluoride (ArF) laser as a light source, or an electron beam (EB) exposure device. In this manner, for example, a striped resist pattern 53 having a pattern width of 3 μm and an interval of 1 μm between adjacent stripes of the resist pattern is formed. Incidentally, the length of the resist pattern 53 in the longitudinal direction (the inward direction into the drawing) is, for example, about 500 μm.

### <Step 7>

Then, as shown in FIG. 6G, grooves 57 in which electrodes (branch portions 45a to 45d and branch portions 49a to 49d) will be formed are formed in the piezoelectric body layer 50.

Specifically, grooves 57 are formed in the piezoelectric body layer 50 masked with the resist pattern 53 by dry etching using fluorine (CF₄, SF₆) gas, chlorine (Cl₂) gas or argon (Ar) gas. For example, each groove 57 is 1 μm wide, 500 μm long (in the inward direction into the drawing) and 3 μm deep. For example, the grooves 57 are arranged at intervals of 2 μm.

### <Step 8>

Then, as shown in FIG. 6H, after the resist pattern 53 is removed, branch layers 59 and 60 which will serve as electrodes (branch portions 45a to 45d and branch portions 49a to 49d) are formed in the grooves 57.

Specifically, a film of copper (Cu) or gold (Au) with a thick of 100 nm is first formed by sputtering. Then, while this film is used as a seed layer, field plating with copper (Cu) or gold (Au) is performed so that the grooves 57 are filled with copper (Cu) or gold (Au). Then, chemical mechanical polishing (CMP) is performed. Thus, branch layers 59 and 60 are formed in the grooves 57.

### <Step 9>

Then, as shown in FIG. 6I, an insulating material film 65 and a head layer 67 are formed on the piezoelectric body layer 50 having the branch layers 59 and 60 formed therein.

Specifically, for example, alumina (Al₂O₃) or titanium oxide (TiO₂) is deposited on the piezoelectric body layer 50 with the branch layers 59 and 60 by sputtering to thereby form an insulating material film 65 with a thick of about 500 nm. This insulating material film 65 will serve as an insulating layer after completion of the whole manufacturing process.

Then, external terminals 42t and 46t are formed on the insulating material film 65. Specifically, after a resist pattern is first formed on the insulating material film 65, openings (not shown) for the aforementioned via pattern are formed in part of the insulating material film 65 by dry etching using chlorine (Cl₂) gas or argon (Ar) gas. Then, the openings are filled with a conducting material by sputtering to thereby form the via pattern (not shown). Further, the same via pattern is also formed in the head portion 37 so as to be connected to the via pattern formed in the insulating material film 65. Thus, the external terminals 42t and 46t are formed.

Then, a head layer 67 for forming a head portion 37 is formed on the insulating material film 65. The head layer 67 includes a magnetic head 5h which has a shield layer, a read element, a write element, etc.

Finally, the wafer-shaped AlTiC substrate 5 having the head layer 67 formed therein thus is cut/separated into individual head sliders 5 by a dicing saw. The head sliders 5 are completed by the aforementioned manufacturing method. Incidentally, each separated head slider 5 is joined to the gimbal 6g of the suspension 6, for example, by an adhesive agent.

FIG. 7 is a typical view showing a displacement state of the actuator in this embodiment. As shown in FIG. 7, when electric potentials are given to the electrodes (the minus-side electrode 42 and the plus-side electrode 46), the head portion 37 moves by a quantity Xd in a direction of an arrow.

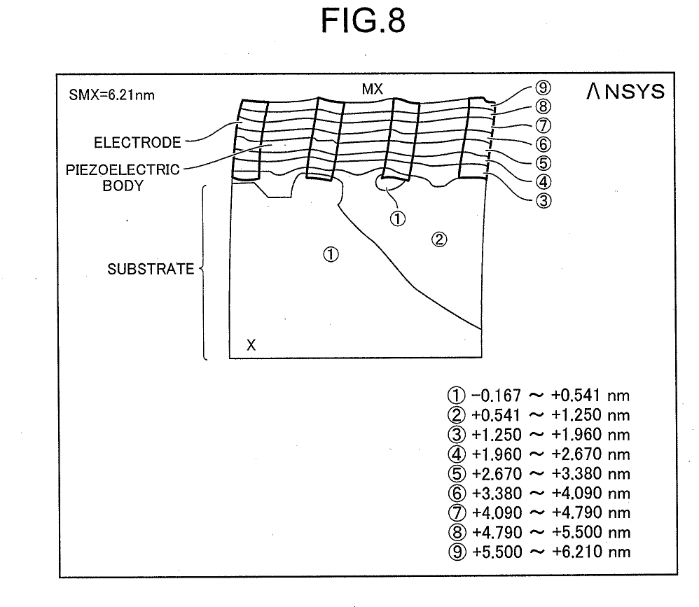

FIG. 8 shows a result of simulation by which displacement of the actuator in the embodiment is confirmed. As shown in FIG. 8, a structure in which electrodes and a piezoelectric body were disposed on an AlTiC substrate was used as a subject of the simulation. As a result of application of a voltage 15V between the electrodes in the structure, it was confirmed that an MX point in the structure was displaced by 6.21 nm in the Xd direction. Incidentally, in FIG. 8, X is a zero point where displacement is zero, and MX is a maximum point where displacement is the largest. Here, copper was used as each electrode and a bulk of a PZT (52/48) composition was used as the piezoelectric body.

### Embodiment 2

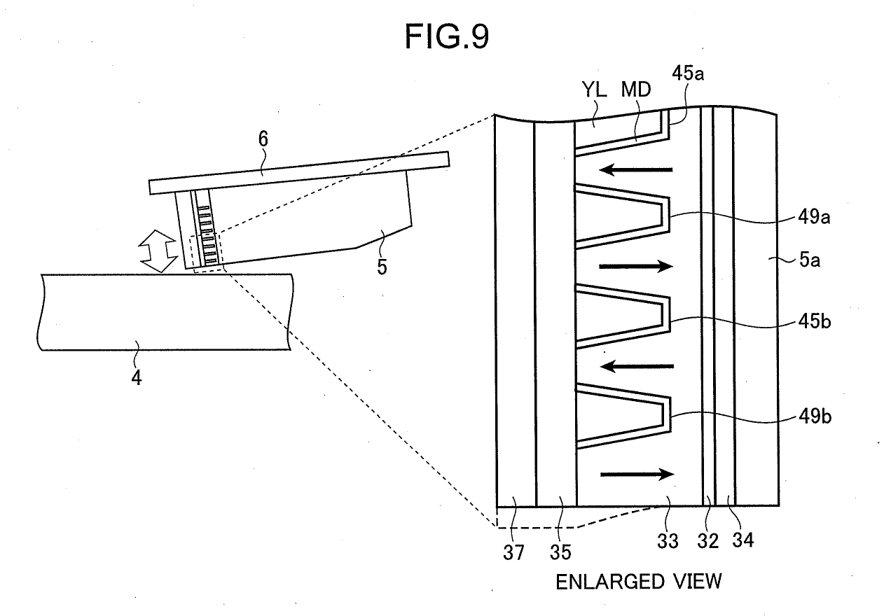

Embodiment 2 will be described below with reference to FIGS. 9 to 14.

FIG. 9 is a schematic sectional view of the head slider and the actuator 33. As shown in an enlarged view in FIG. 9, Embodiment 2 shows an example in which each of electrode portions (the branch portions 45a to 45d and the branch portions 49a to 49d) includes a low Young's modulus portion YL low in Young's modulus of elasticity, and a conductor coating portion MD with which a front surface of the low Young's modulus portion YL is coated. A material higher in Young's modulus of elasticity than the low Young's modulus portion YL is used as the material of the conductor coating portion MD. That is, each electrode portion has a surface portion (high Young's modulus portion) made of a conducting material, and an inner portion (low Young's modulus portion) lower in Young's modulus of elasticity than the conducting material.

When the rigidity of the electrode portions per se is high, deformation of the piezoelectric elements 33aa to 33dd is disturbed by the rigidity of the electrode portions even if a distortion force is produced by the piezoelectric elements 33aa to 33dd. Therefore, in Embodiment 2, configuration is made so that the electrodes for activating the piezoelectric elements are provided only in the surface to reduce the rigidity of the electrode portions per se. When the configuration is made thus, the piezoelectric elements 33aa to 33dd can be displaced easily. Incidentally, the low Young's modulus portion YL needs heat resistance against a head formation process which will be performed later, in addition to the low Young's modulus of elasticity.

The low Young's modulus portion YL may be a conductive material or may be an insulative material. Specific examples of the material forming the low Young's modulus portion YL are polyimide heat-resistant resins, aramid heat-resistant resins, and porous inorganic materials such as porous silica, foam metal, etc.

On the other hand, examples of the material allowed to be used as the conductor coating portion MD which is the high Young's modulus portion are metals such as copper (Cu), nickel (Ni), aluminum (Al), platinum (Pt) and gold (Au), and alloys of these metals. Besides these materials, conductive ceramics such as iridium oxide (IrO₂) and strontium ruthenate (SrRuO₃) can be used.

### —Manufacturing Process—

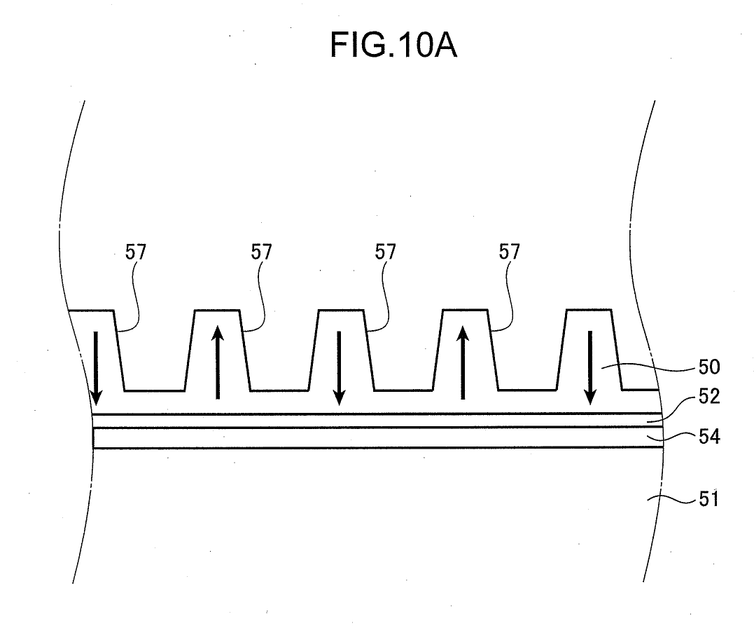

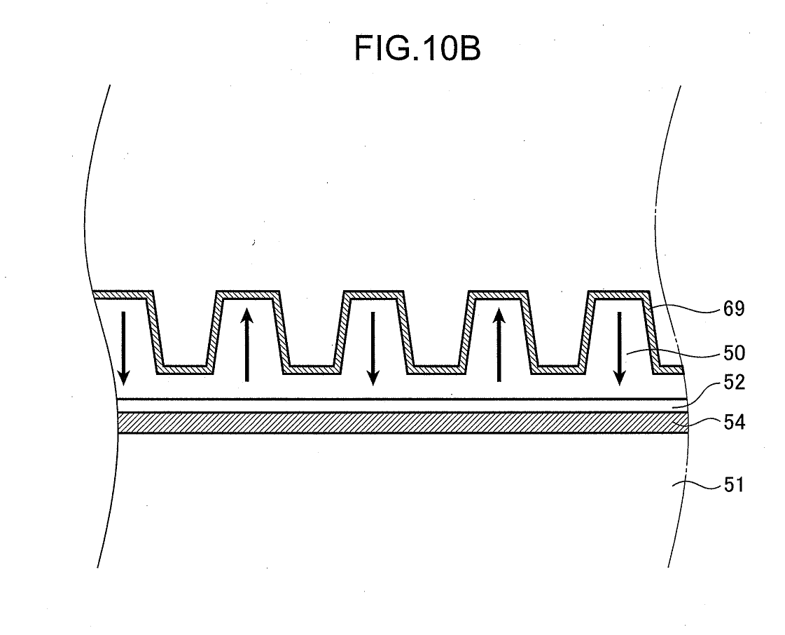

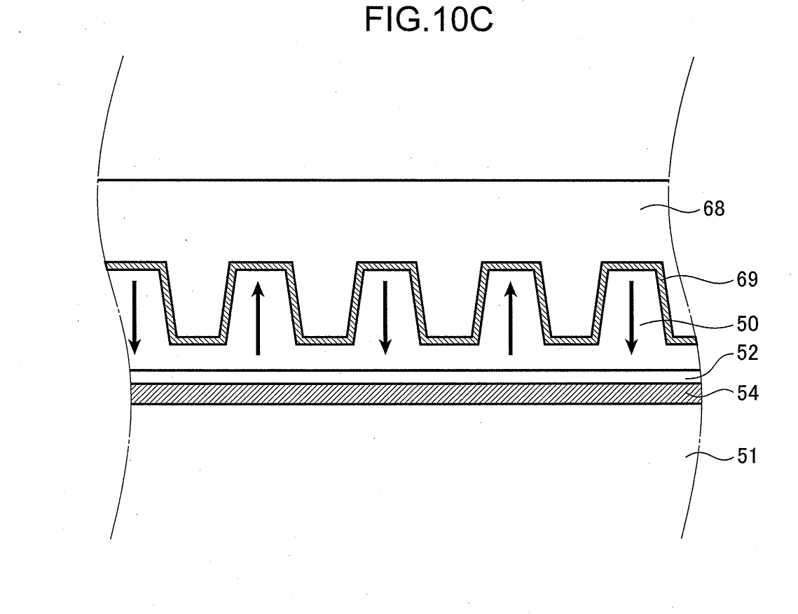

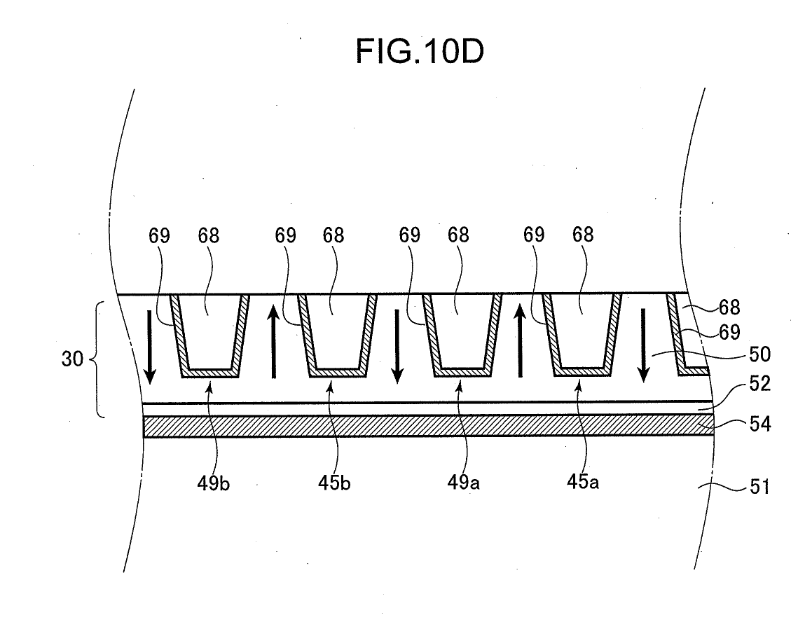

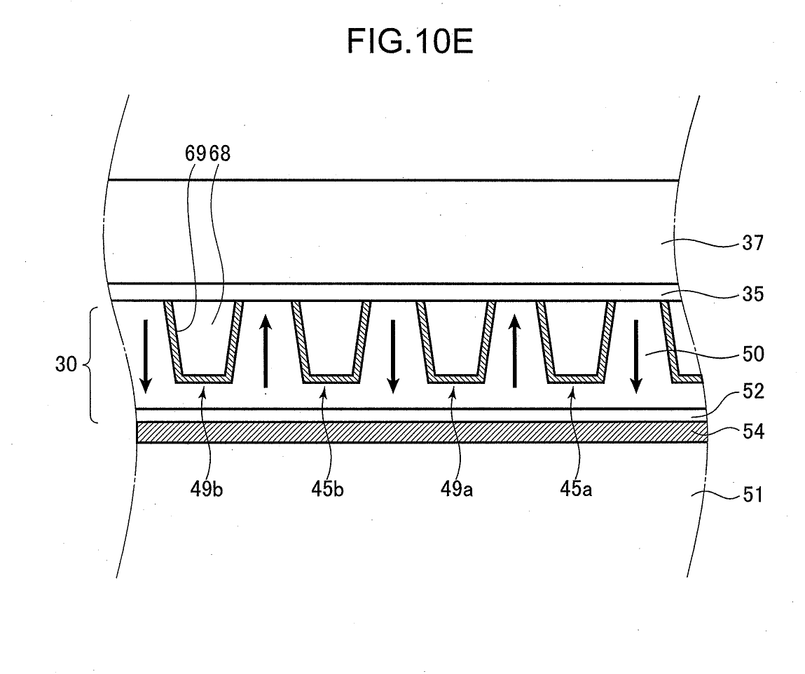

The manufacturing process is as shown in FIGS. 10A to 10E.

The initial process (specifically the steps 1 to 7 in Embodiment 1) is performed in the same manner as Embodiment 1 and description thereof will be omitted. The process after the step 7 in Embodiment 1 will be described below. FIG. 10A is a view showing the step 7 in Embodiment 1 (a view after the resist pattern 53 is removed from FIG. 6G). That is, FIG. 10A is a view showing a state after the grooves 57 for forming the electrode portions (the branch portions 45a to 45d and the branch portions 49a to 49d) are formed in the piezoelectric body layer 50.

### <Step 18>

Then, as shown in FIG. 10B, an MD thin film 69 for forming a conductor coating portion MD is formed on front surfaces of the grooves 57 by sputtering, vacuum vapor deposition, chemical vapor deposition (CVD), etc. On this occasion, the MD thin film 69 is formed so thinly that recesses are formed in positions of the MD thin film 69 corresponding to the grooves 57 after the formation of the MD thin film 69. Then, as shown in FIG. 10C, the recesses after the formation of the MD thin film 69 are filled with a low Young's modulus material 68 for forming a low Young's modulus portion YL. Incidentally, the filling is performed by spin coating or dip coating. Then, a CMP process is performed. Thus, branch portions (45a to 45d and 49a to 49d) for forming electrodes are formed (FIG. 10D).

### <Step 19>

Then, in step 19, an insulating material film 65 and a head layer 67 are formed on the piezoelectric body layer 50 having these branch portions (45a to 45d and 49a to 49d) formed therein. That is, the insulating material film 65 and the head layer 67 are formed on the displacement portion 30. The insulating material film 65 and the head layer 67 are formed in the same manner as in Embodiment 1. The head slider 5 is completed by the aforementioned manufacturing method (FIG. 10E).

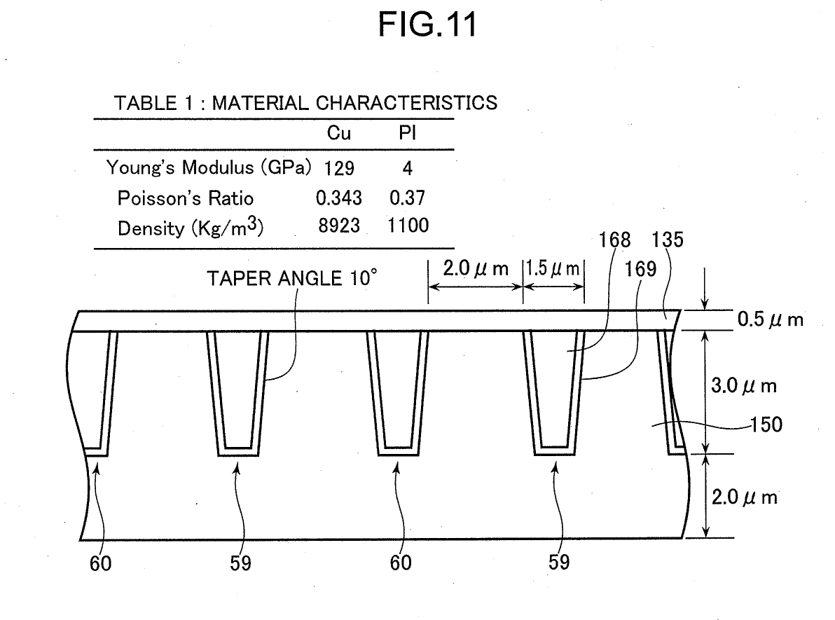

FIG. 11 is a view showing a condition used for displacement simulation of the actuator 33 in another embodiment. That is, the condition was set so that each of the electrodes (branch layers 59 and 60) formed in a piezoelectric body layer 150 was made of an MD thin layer 169 and a low Young's modulus material 168. Here, the piezoelectric body layer 150 is a layer corresponding to the piezoelectric body layer 50. In addition, the branch layers 59 and 60 are layers corresponding to the branch portions (45a to 45d and 49a to 49d).

A condition corresponding to the insulating layer 35 was set so that a 0.5 μm-thick insulating layer 135 made of silicon oxide was formed on the front surface of the piezoelectric body layer 150 with the branch layers 59 and 60 formed therein. As shown in FIG. 11, each of the branch layers 59 and 60 was formed to have a size with a width of 1.5 μm and a depth of 3.0 μm and to have a taper angle set at 10°. Further, the distance between adjacent electrodes was set at 2.0 μm. When the taper angle is added to each of the electrodes (the branch layers 59 and 60) in this manner, a uniform thin film can be formed in each of the groove portions formed in the piezoelectric body layer 150. When the taper angle is about 10°, there is little influence on the displacement quantity. As shown in Table 1, a condition was set so that copper (Cu) with a Young's modulus of 129 GPa was used as the material of the MD thin film 169.

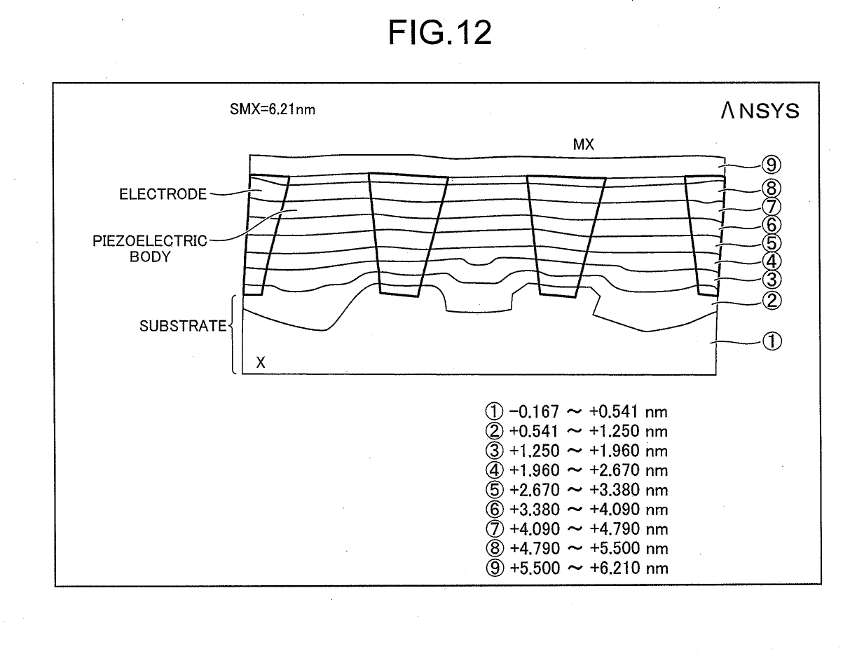

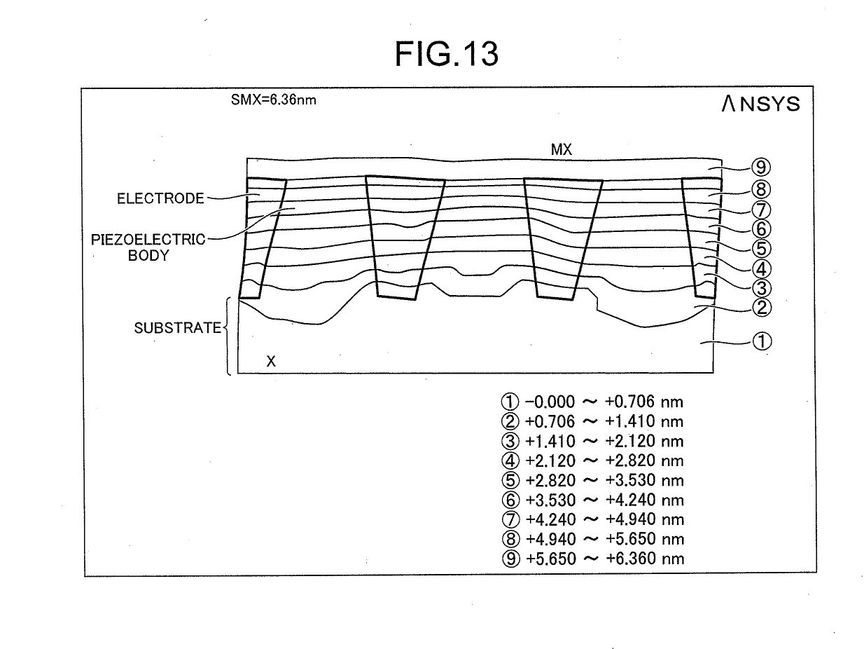

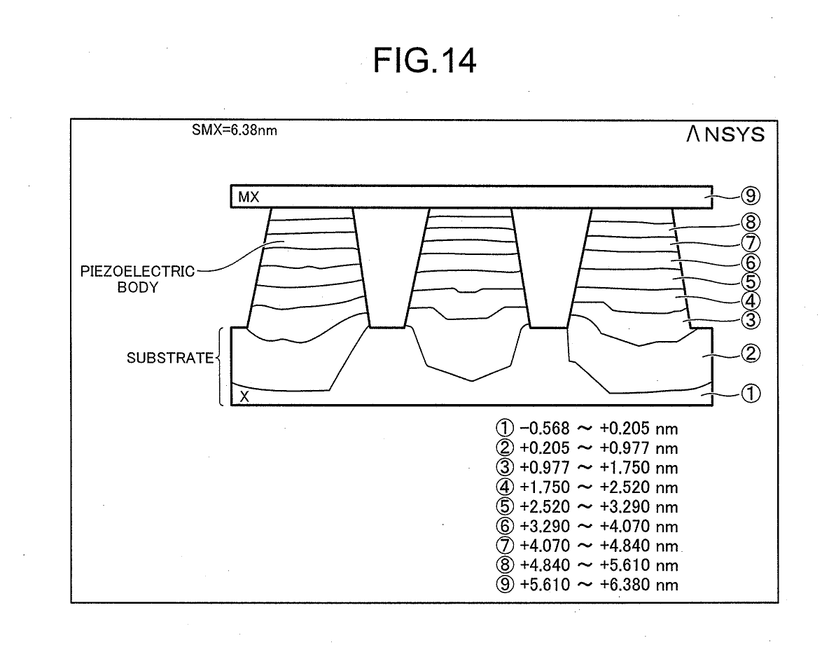

FIG. 12 shows a result of simulation in the case where copper (Cu) with a Young's modulus of 129 GPa was used as the low Young's modulus material 168. FIG. 13 shows a result of simulation in the case where polyimide (PI) with a Young's modulus of 4 GPa was used as the low Young's modulus material 168. FIG. 14 shows a result of simulation in the case where the portions of the low Young's modulus material 168 were replaced by hollows.

In FIG. 12, the maximum displacement quantity point MX was displaced by 6.21 nm. In FIG. 13, the maximum displacement quantity point MX was displaced by 6.36 nm. In FIG. 14, the maximum displacement quantity point MX was displaced by 6.38 nm. As described above, it is apparent that the displacement quantity increases as the material used as the low Young's modulus material 168 is softened.

Although the displacement quantity in FIG. 14 is the largest, the strength of the head slider 5 is weakened by the hollow portions when the structure shown in FIG. 14 is used. Therefore, from the viewpoint of practical use, the structure shown in FIG. 13 is preferred. As described above, it is apparent that when a low Young's modulus material is used in part of each electrode, a larger displacement quantity can be ensured compared with the case where a high Young's modulus material is used in the whole of each electrode.

### Embodiment 3

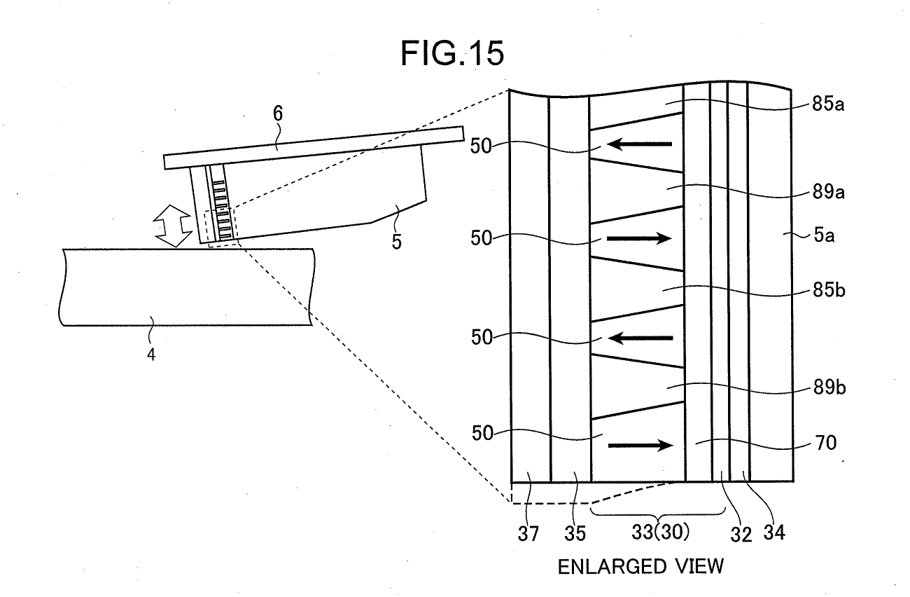

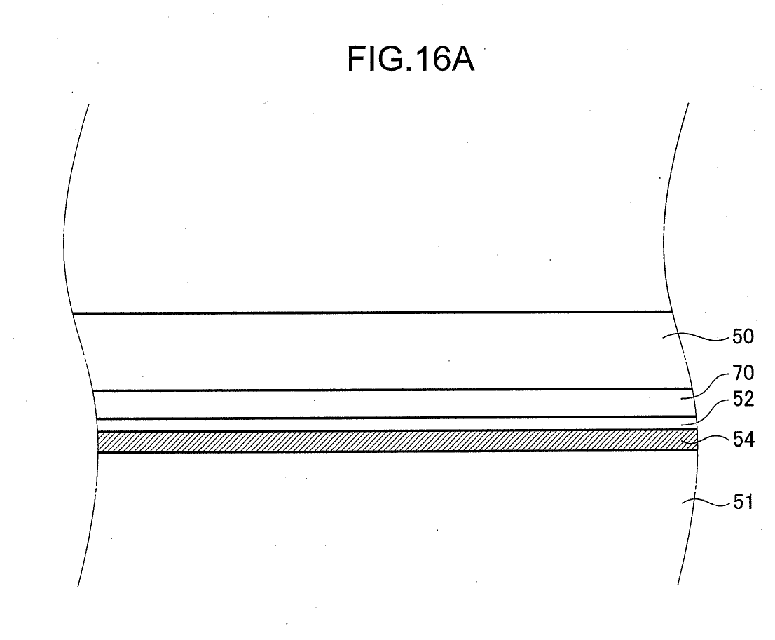

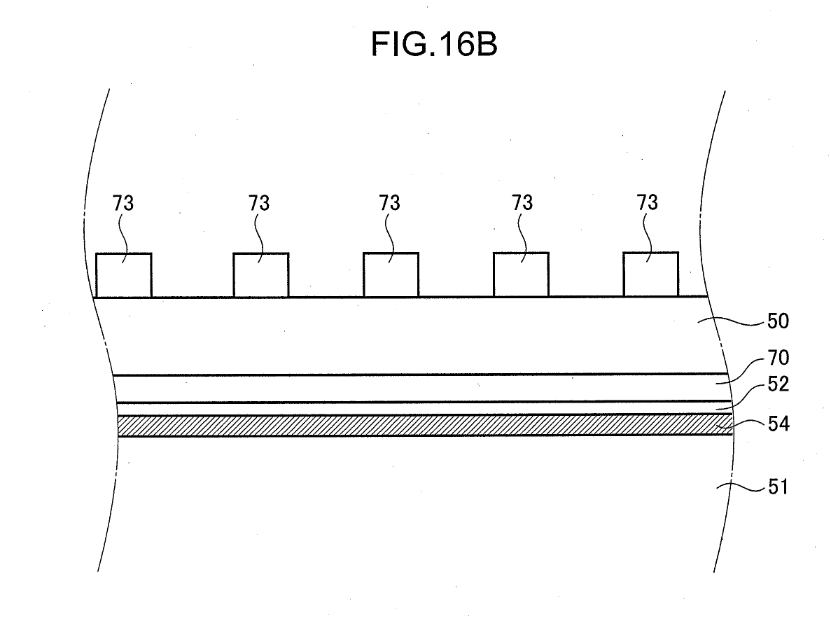

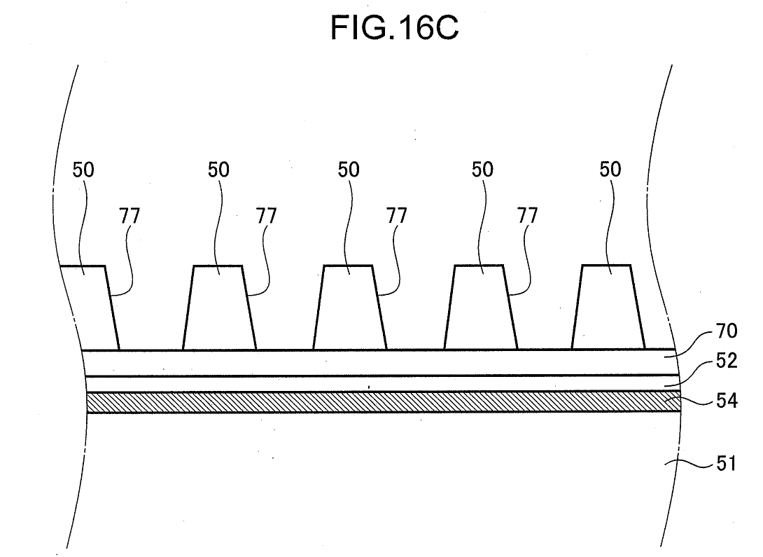

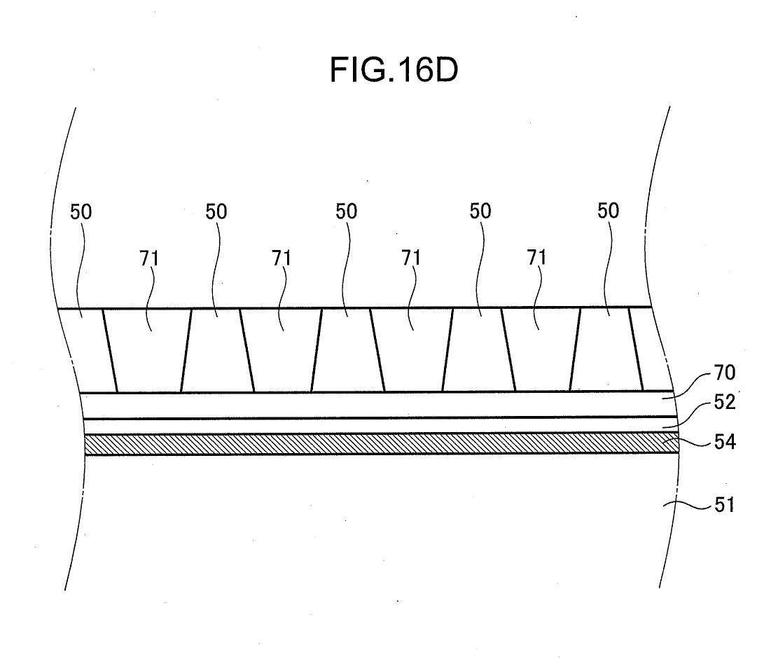

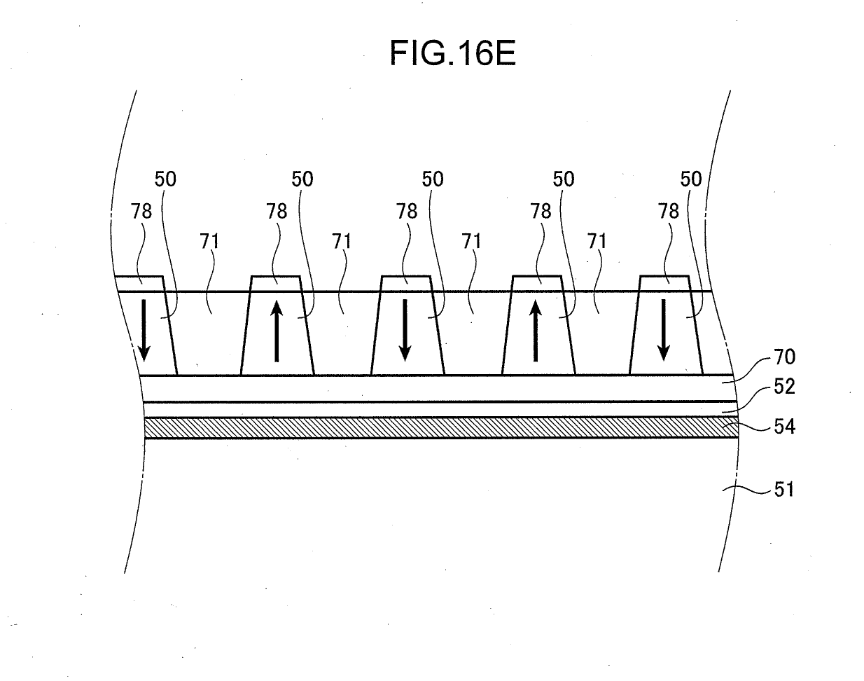

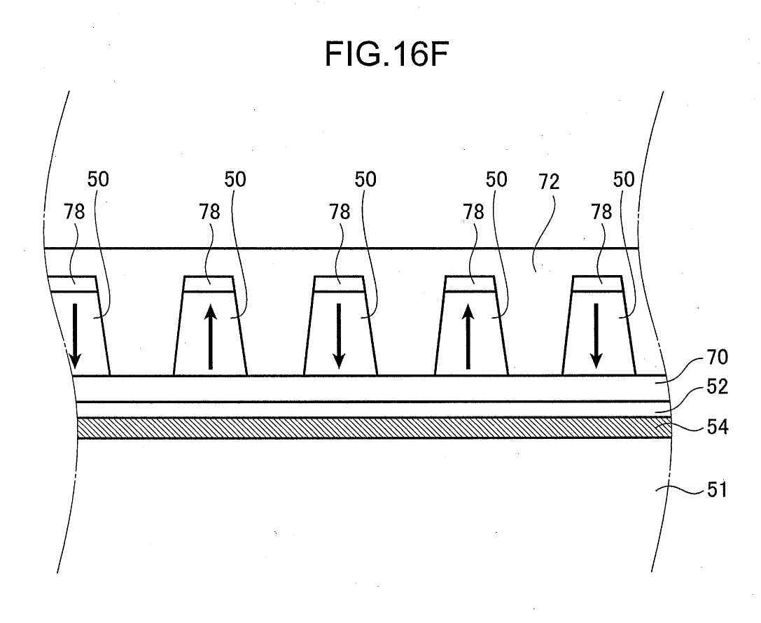

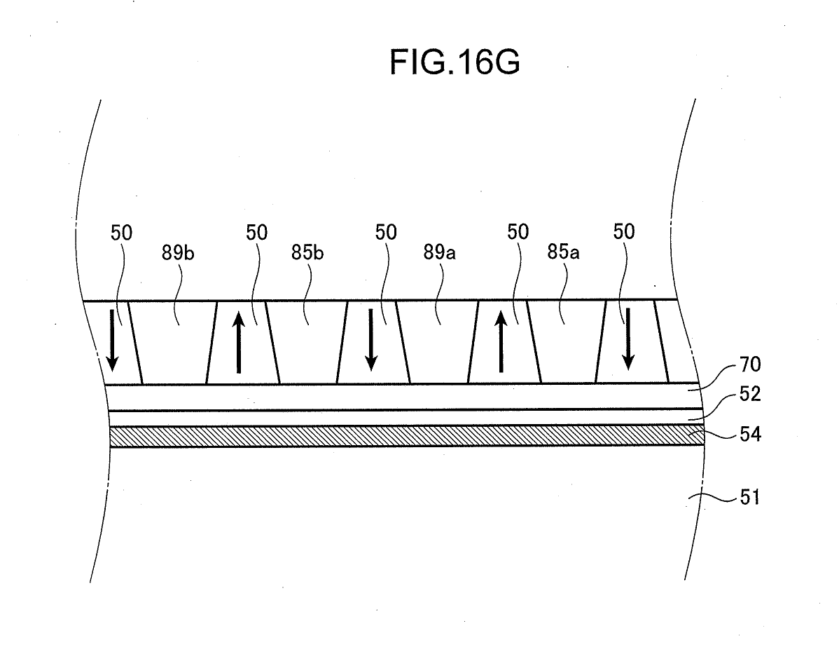

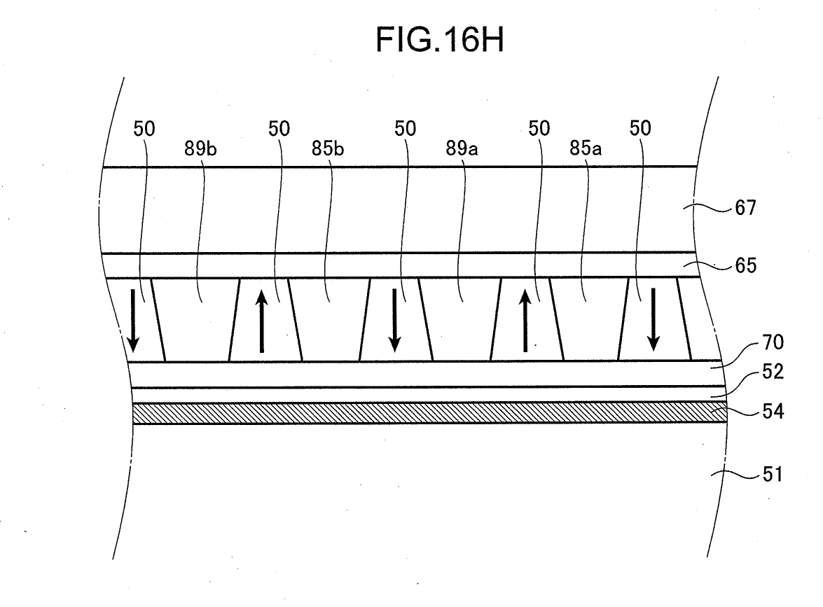

Embodiment 3 will be described below with reference to FIG. 15 and FIGS. 16A to 16H.

FIG. 15 is a schematic sectional view showing a head slider 5 in Embodiment 3. As shown in an enlarged view in FIG. 15, in Embodiment 3, an insulating underlying layer 70 is formed between electrode portions 45 and a lower electrode 32. Although FIG. 9 shows an example in which each of the electrode portions (the branch portions 45a to 45d and the branch portions 49a to 49d) has a low Young's modulus portion YL and a conductor coating portion MD, FIG. 15 shows an example in which each electrode portion is provided as a single layer made of a conductive material for convenience's sake. Incidentally, each electrode portion in Embodiment 3 may be formed to have a low Young's modulus portion YL and a conductor coating portion MD, similarly to each electrode portion shown in FIG. 9 (i.e. Embodiment 2).

A process of forming grooves in the piezoelectric body layer 50 is generally performed by dry etching as described in Embodiment 1. In the dry etching process, etching time is generally controlled to adjust the depth of each groove. Accordingly, the depth of the groove as a result of the process is affected by the state (forming state) of the piezoelectric body film 50 or the condition for the dry etching process. As described above, it is not easy to equalize the depths of the grooves accurately when the depths of the grooves are intended to be controlled by the etching time. As a result, there is a problem that the actuator characteristic cannot be stabilized because of wide variation (in groove depth) according to each lot. When the grooves are too deep, the distance between adjacent ones of the electrode portions (the branch portions 45a to 45d and the branch portions 49a to 49d) and the lower electrode 32 is reduced so that insulation performance between the electrode portions and the lower electrode 32 is lowered.

A underlying layer having a material composition different from that of the piezoelectric body layer 50 is formed between the electrode portions and the lower electrode 32. When such a underlying layer is provided, plasma emission spectrochemical analysis can be applied during dry etching so that variation in groove depth can be suppressed.

### —Manufacturing Process—

A manufacturing process in Embodiment 3 is shown in FIGS. 16A to 16H. When the manufacturing process is performed in the same manner as the manufacturing method shown in Embodiment 1 (or Embodiment 2), description of the manufacturing process will be omitted.

Since the initial process (specifically the steps 1 and 2 in Embodiment 1) is formed in the same manner as in Embodiment 1, description of the initial process will be omitted. Step 3 and steps following the step 3 in Embodiment 1 will be described below.

### <Step 23>

FIG. 16A is a view of a step following the step 2 of Embodiment 1. In this step, as shown in FIG. 16A, an insulating underlying layer 70 is formed on the lower electrode layer 52 and then a piezoelectric body layer 50 is formed on the insulating underlying layer 70. The insulating underlying layer 70 is formed of a material having a composition different from that of the piezoelectric body layer 50. For example, BaTiO₃ is used as the material of the insulating underlying layer 70 while PZT is used as the material of the piezoelectric body layer 50. Specifically, for example, a 1 μm-thick insulating underlying layer 70 of BaTiO₃ is first formed by sputtering. Successively, a 4 μm-thick piezoelectric body layer 50 of PZT is formed on the insulating underlying layer 70 also by sputtering. Here, it is preferable that the formation of the piezoelectric body layer 50 is continued from the formation of the insulating underlying layer 70 while the insulating underlying layer 70 is not exposed to the outside air.

### <Step 24>

Then, as shown in FIG. 16B, a resist pattern 73 (a resist pattern 73 as a mask for forming grooves) is formed on a surface of the piezoelectric body layer 50. For example, the resist pattern 73 is formed in the same manner as the resist pattern 53 in the step 6 of Embodiment 1.

### <Step 25>

Then, as shown in FIG. 16C, grooves 77 are formed in the piezoelectric body layer 50. The grooves 77 are formed in the same manner as the grooves 57 in Embodiment 1. Incidentally, in this step, the following well-known plasma emission spectrochemical analysis is performed in order to improve accuracy in forming grooves. First, etching is performed while the emission spectrum of etching plasma is monitored by a detector. The etching is terminated when emission due to barium (Ba) is detected by the detector. For example, a wavelength dispersion type detector made by Otsuka Electronics Co., Ltd. can be used as the detector. The wavelength dispersion type detector expresses the intensity of light with a specific wavelength in a spectrum. When, for example, a wavelength of (Ba) etc. is selected and the specific wavelength is fixed to the selected wavelength, the point of completion of etching can be detected by the detector. Successively, after the surface of the piezoelectric body layer 50 processed by oxygen ashing is cleaned, annealing is performed in an oxygen atmosphere. By the annealing in an oxygen atmosphere, damage given to the surface of the piezoelectric body layer 50 by plasma can be recovered.

Since the insulating underlying layer 70 is not present between the electrode portions (the branch portions 45a to 45d and the branch portions 49a to 49d), the material for forming the insulating underlying layer 70 need not be a piezoelectric material if the material is an insulating material. It is however preferable that the insulating underlying layer 70 is a layer (piezoelectric body) made of a piezoelectric material because a leakage of an electric field from the electrode portions acts on the insulating underlying layer 70. It is further preferable that the insulating underlying layer 70 has the same crystal structure as that of the piezoelectric body layer 50 because the insulating underlying layer 70 is generally formed so as to be in contact with the piezoelectric body layer 50. It is further preferable that the insulating underlying layer 70 has a grating constant close to that of the piezoelectric body layer 50 in addition to the same crystal structure as that of the piezoelectric body layer 50.

When, for example, the aforementioned PZT is used as the material of the piezoelectric body layer 50, it is preferable that perovskite type oxide which has the same crystal structure as that of PZT is used as the material of the insulating underlying layer 70. Materials as candidates for the piezoelectric body layer 50 and the insulating underlying layer 70 and their grating constants will be listed below.

Left Side: Material Name/Right Side: Grating Constant (unit: nm)

(1) Candidate for Piezoelectric Body Layer 50

PZT: Pb(Zr,Ti)O₃/0.401

(2) Candidates for Insulating Underlying Layer 70

PLZT: (Pb,La)(Zr,Ti)O₃/0.408

PMNT: Pb(Mg,Nb,Ti)O₃/0.401

BaTiO₃/0.399

BST: (Ba,Sr)TiO₃/0.399-0.39

When the piezoelectric body film 50 is made of PZT, the Zr/Ti ratio in the insulating underlying layer 70 may be changed. It is however preferable that the insulating underlying layer 70 has any element not contained in PZT so that the insulating underlying layer 70 can be detected easily by plasma emission spectrochemical analysis. In addition, it is preferable that the insulating underlying layer 70 is slower in etching speed than the piezoelectric body layer 50. Moreover, when BaTiO₃ or BST is used as the material of the insulating underlying layer 70 while the piezoelectric body layer 50 is made of PZT, the difference in etching speed between the insulating underlying layer 70 and the piezoelectric body layer 50 can be increased to improve processing accuracy. That is, use of the aforementioned materials (in combination to increase the difference in etching speed) as the materials for forming the piezoelectric body layer 50 and the insulating underlying layer 70 is preferred to use of the same Pb oxide material as the materials for forming the piezoelectric body layer 50 and the insulating underlying layer 70.

It is preferable that the dielectric constant of the insulating underlying layer 70 is higher than that of the piezoelectric body layer 50. This is because the electric field applied to the piezoelectric body layer 50 is more intense than the electric field applied to the insulating underlying layer 70 during the step of polarizing the piezoelectric body layer 50. Therefore, when the piezoelectric body layer 50 is made of PZT, for example, PMNT, BaTiO₃, BST, etc. can be used as the material allowed to be used for the insulating underlying layer 70 to make the dielectric constant of the insulating underlying layer 70 higher than that of PZT.

### <Step 26>

Then, as shown in FIG. 16D, a film of a resin material (not shown) is formed on the piezoelectric body layer 50 having the grooves 77 formed therein, so that a resin layer 71 is formed. The resin layer 71 plays a role of a sacrificial layer which will be removed finally. In the step of forming the resin material film, the resin material film is formed, for example, by spin coating so that at least the inside of each groove 77 is filled with the resin material. Then, a surface of the formed resin material film is cut, for example, by a CMP method until at least an upper surface of the piezoelectric body layer 50 is exposed. Thus, the resin layer 71 made of the resin material is formed in the inside of each groove 77 in the piezoelectric body layer 50. As a result, the surfaces of the piezoelectric body layer 50 and the resin layer 71 are smoothened continuously.

### <Step 27>

Then, as shown in FIG. 16E, local electrodes 78 are formed on the smoothened surface of the piezoelectric body layer 50. For example, the local electrodes 78 are formed of the same material and in the same manner as the local electrodes 58 in the step 5 of Embodiment 1. Then, the piezoelectric body layer 50 is polarized by applying an electric field between the lower electrode layer 52 and each local electrode 78. In Embodiment 3, first, every other local electrode 78 is selected from the local electrodes 78 and a polarizing process is applied to regions of the piezoelectric body layer 50 corresponding to the selected local electrodes 78. Then, the remaining local electrodes 78 are selected and a polarizing process in a direction reverse to the previous polarizing process is applied to regions of the piezoelectric body layer 50 corresponding to the selected local electrodes 78.

### <Step 27>

Then, as shown in FIG. 16F and FIG. 16G, electrode portions (branch portions 85a to 85d and branch portions 89a to 89d) are formed in the portions of the grooves 77. Specifically, the resin layer 71 remaining in the inside of each groove 77 is first removed by etching (not shown). Then, as shown in FIG. 16F, a conductive material layer 72 is formed on the piezoelectric body layer 50 from which the resin layer 71 has been removed. The conductive material layer 72 is formed as follows. First, a film of copper (Cu) or gold (Au) with a thick of about 100 nm is formed by sputtering. Then, while this film is used as a seed layer, field plating with copper (Cu) or gold (Au) is performed so that the grooves 77 are filled with copper (Cu) or gold (Au).

Then, as shown in FIG. 16G, a front surface of the conductive material layer 72 is polished, for example, by a CMP method. On this occasion, the local electrodes 78 are also polished so that the upper surface of the piezoelectric body layer 50 is exposed. When the local electrodes 78 are polished (ground) in this manner until the upper surface of the piezoelectric body layer 50 is exposed, an electrode portion made of the conductive material are formed in the inside of each groove 77 in the piezoelectric body layer 50. That is, the branch portions 85a to 85d (branch portions 85) made of the conductive material and the branch portions 89a to 89d (branch portions 89) made of the conductive material are formed in the inside of the grooves 77 of the piezoelectric body layer 50. Incidentally, the surface of the piezoelectric body layer 50 and the surfaces of the electrode portions are smoothened continuously because of polishing by the CMP method.

The material and formation method of the branch portions 85 and 89 can be made here in the same manner as those of the branch portions 45 and 49 in the step 8 of Embodiment 1. In this manner, the respective branch portions 85 and 89 can be electrically insulated from one another.

### <Step 28>

Then, as shown in FIG. 16H, an insulating material film 65 and a head layer 67 are formed. The insulating material film 65 and the head layer 67 can be formed, for example, in the same manner as in the step 9 of Embodiment 1.

The depth accuracy of the electrode portions in the actuator 33 produced by the aforementioned method was ±0.1 μm. On the contrary, in the related-art method, that is, when the processing time for etching was controlled to adjust the depth of each groove, the depth accuracy of the electrode portions was ±0.5 μm. As described above, processing accuracy was improved greatly by the method according to Embodiment 3. When a underlying layer having a material composition different from that of the piezoelectric body layer 50 is provided between the electrode portions and the lower electrode 32 and plasma emission spectrochemical analysis is applied as described above, a point of time of completion of etching can be detected accurately.

### Embodiment 4

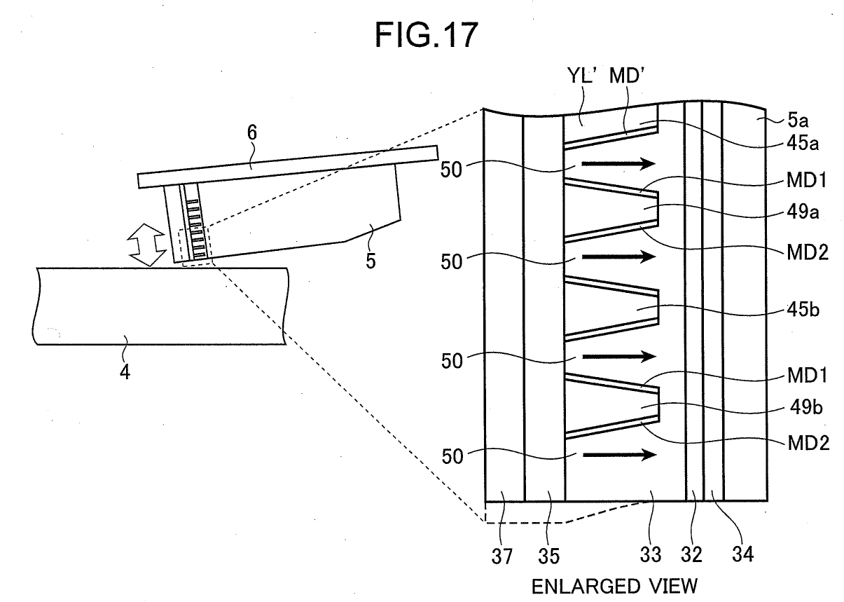

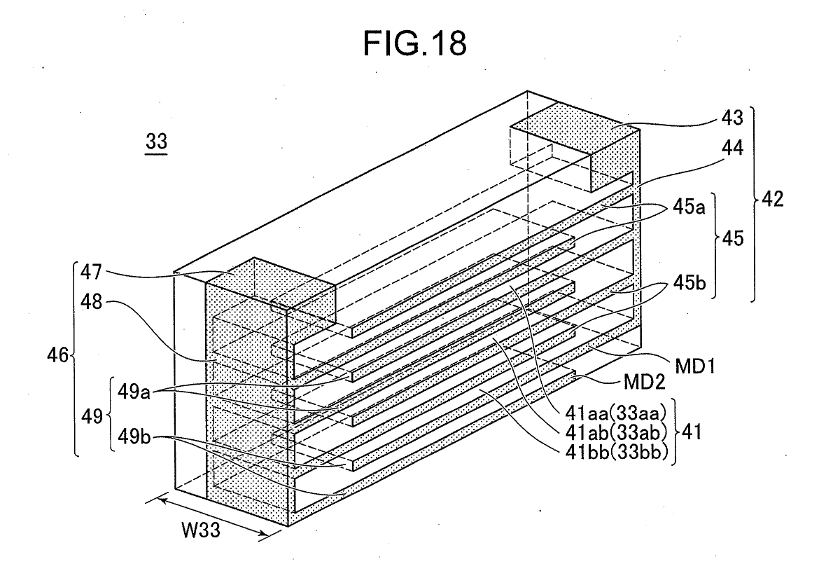

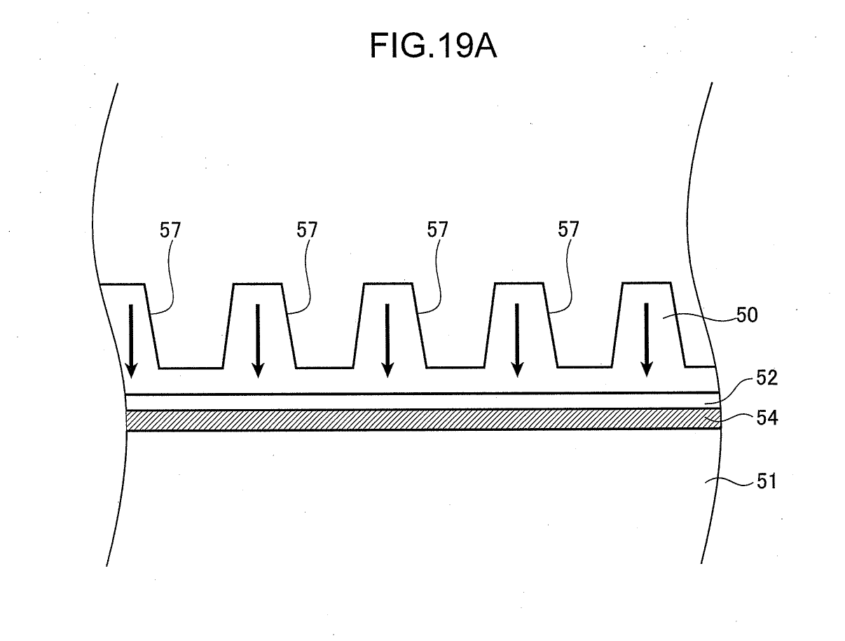

Embodiment 4 will be described below with reference to FIGS. 17 and 18.

FIG. 17 is a schematic sectional view of a head slider according to Embodiment 4. As shown in FIG. 17, each electrode is configured so that two conductor coating portions MD′ are disposed on opposite sides of a low Young's modulus portion YL′, that is, a low Young's modulus portion YL′ is wedged between two conductor coating portions MD′. An electrode MD1 which is one of the conductor coating portions MD′ (the two conductor coating portions MD′ provided on the opposite sides of the low Young's modulus portion YL′) is electrically insulated from the other conductor coating portion MD2. An electric potential different from that applied to the conductor coating portion MD2 is applied to the conductor coating portion MD1.

FIG. 18 is a perspective view showing a schematic structure of an actuator 33 in Embodiment 4. As shown in FIG. 18, for example, each of branch portions 45a and 45b has two electrodes one of which is connected to a minus-side electrode 42 while the other is connected to a plus-side electrode 46.

Similarly, each of branch portions 49a and 49b has two electrodes one of which is connected to the minus-side electrode 42 while the other is connected to the plus-side electrode 46. Piezoelectric body films 41aa, 41ab and 41bb etc. are disposed between these branch portions.

### —Manufacturing Process—

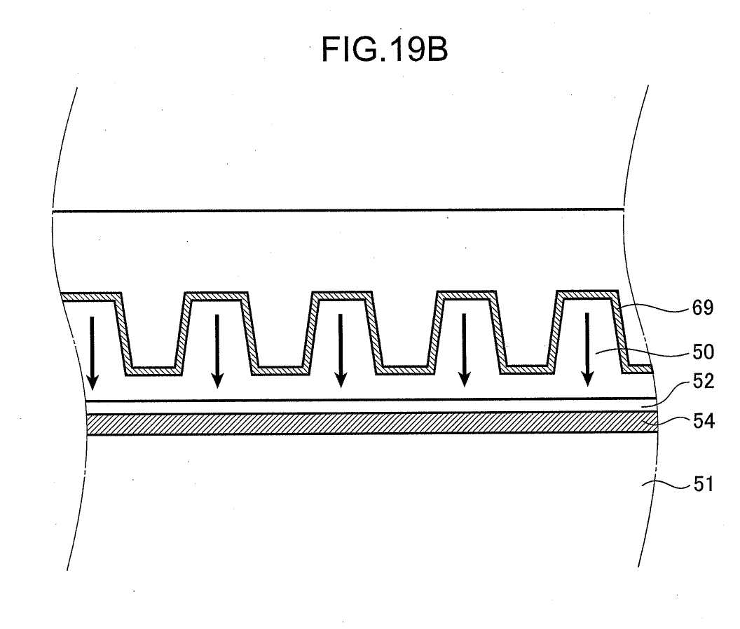

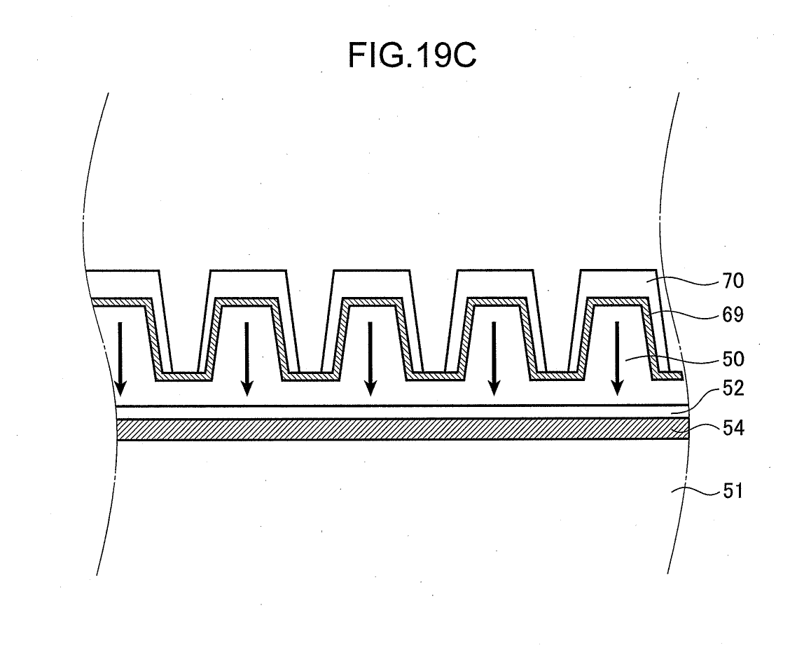

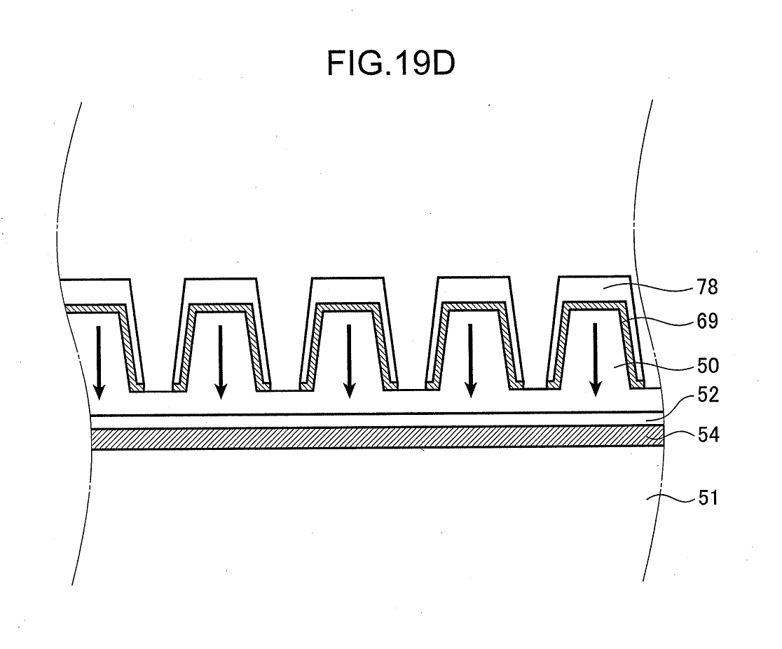

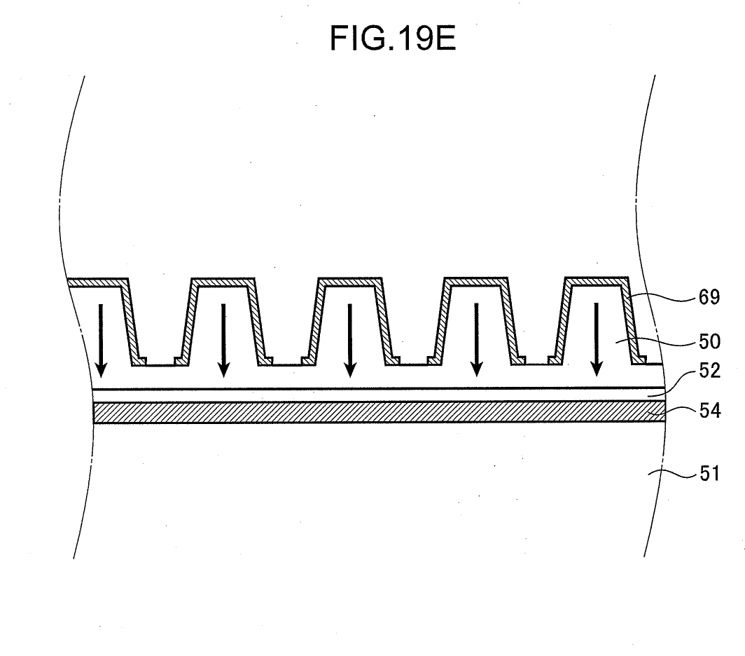

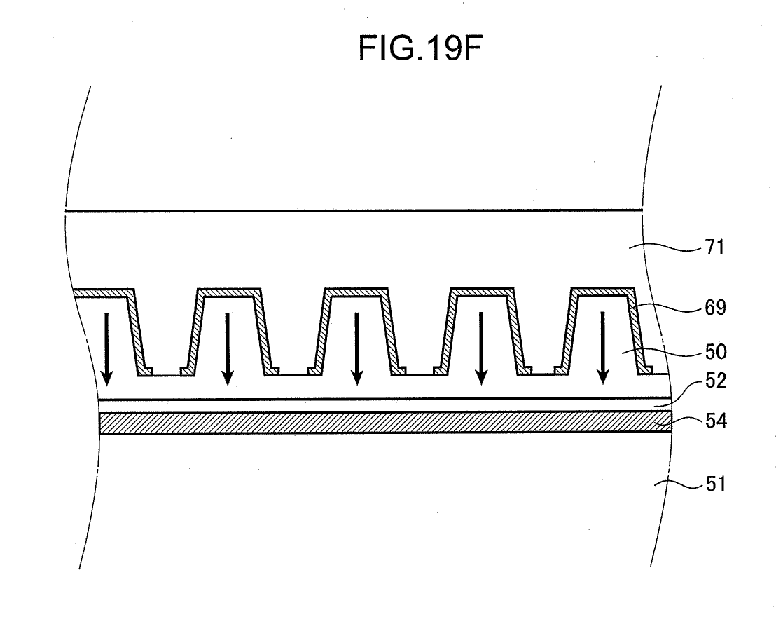

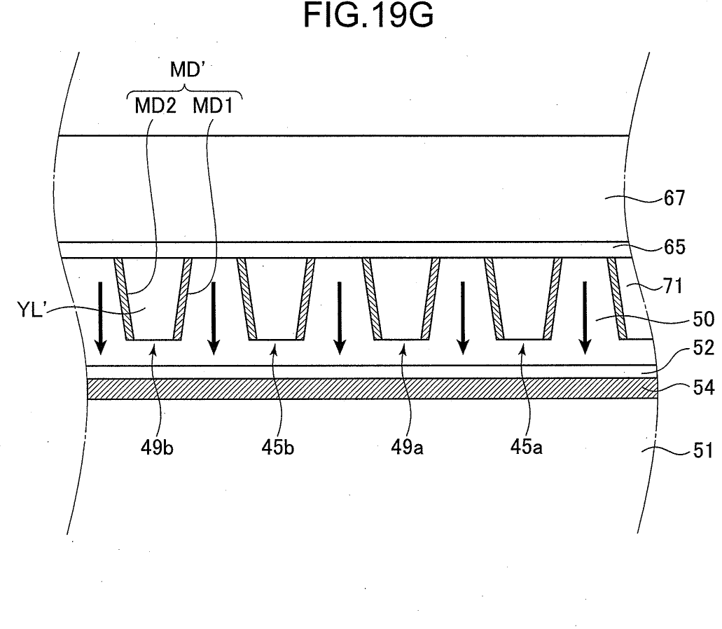

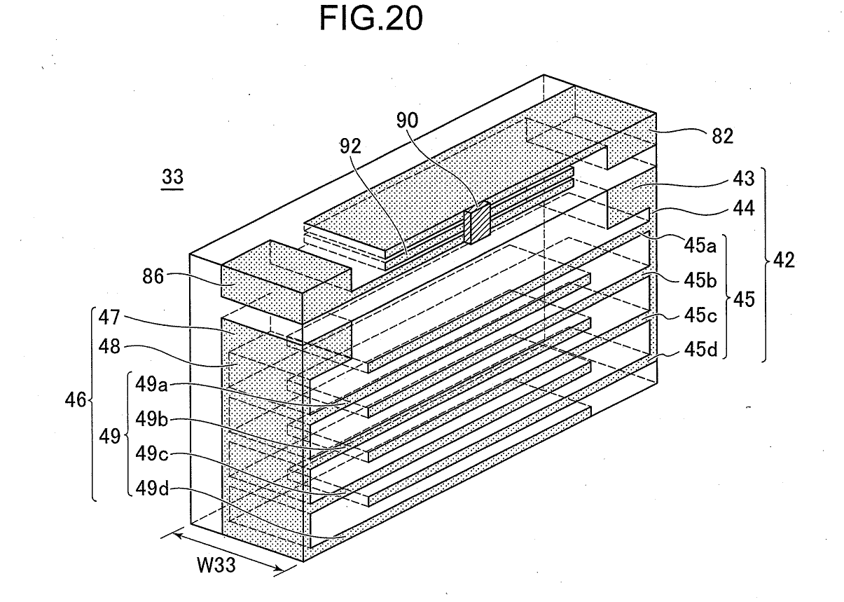

The manufacturing process in Embodiment 4 is shown in FIGS. 19A to 19G. When the manufacturing process in Embodiment 4 is performed in the same manner as the manufacturing method shown in Embodiment 1 (or Embodiment 2 and Embodiment 3), description thereof will be omitted.

Since the initial process (specifically, the steps 1 to 7 in Embodiment 1) is formed in the same manner as in Embodiment 1, description of the initial process will be omitted. Step 7 and the steps following step 7 in Embodiment 1 will be described below. FIG. 19A is a view showing step 7 in Embodiment 1 (a view after the resist pattern 53 is removed from FIG. 6G). That is, FIG. 19A shows the state that grooves 57 for forming electrode portions (the branch portions 45a to 45d and the branch portions 49a to 49d) are formed in the piezoelectric body layer 50. Incidentally, at this stage, the piezoelectric body layer 50 has been polarized. As shown in FIG. 19A, the directions of polarization are made the same to be one direction, differently from other embodiments.

### <Step 38>

Then, as shown in FIG. 19B, an MD thin film 69 for forming conductor coating portions MD is formed on surfaces of the grooves 57 by sputtering, vacuum vapor deposition, CVD, etc. On this occasion, the MD thin film 69 is formed so thinly that recesses are formed in positions corresponding to the grooves 57 in the MD thin film 69 after formation of the MD thin film 69.

### <Step 39>

Then, as shown in FIG. 19C, a resist pattern 78 is formed on the MD thin film 69. Specifically, a photoresist material is first applied on the whole area of a front surface of the MD thin film 69 so that the inner walls of the recesses corresponding to the grooves 57 are also coated with the photoresist material. Then, as shown in FIG. 19B, the photoresist material is partially removed from the centers (bottoms) of the recesses by exposure and development to thereby form a resist pattern 78.

### <Step 40>

Then, as shown in FIG. 19D, the MD thin film 69 is partially removed with use of the resist pattern 78 as a mask. Specifically, dry etching using argon (Ar) gas etc. is performed on the substrate having the resist pattern 78 formed therein. The MD thin film 69 is removed from the centers (i.e. portions where the photoresist material has been removed in the step 39) of the recesses by the dry etching process.

### <Step 41>

Then, as shown in FIG. 19E, the resist pattern 78 is removed from the substrate processed by the step 40.

### <Step 42>

Then, as shown in FIG. 19F, an insulating material layer 71 is formed on the substrate after the resist pattern 78 is removed from the substrate. The formation of the insulating material layer 71 is performed in such a manner that the substrate is filled with an insulating material by spin coating or dip coating. Incidentally, a heat-resistant resin such as a polyimide resin or an aramid resin or a porous inorganic material such as porous silica or foam metal can be used as the insulating material.

### <Step 43>

Then, as shown in FIG. 19G, a CMP process is performed so that branch portions (45a to 45d and 49a to 49d) for forming electrodes are formed.

### <Step 44>

Then, an insulating material film 65 and a head layer 67 are formed on the piezoelectric body layer 50 having the branch portions (45a to 45d and 49a to 49d) formed therein. That is, the insulating layer 35 and the head portion 37 are formed on the displacement portion 30. The insulating material film 65 and the head layer 67 are formed in the same manner as in Embodiment 1. The head slider 5 is completed by the aforementioned manufacturing method.

### Embodiment 5

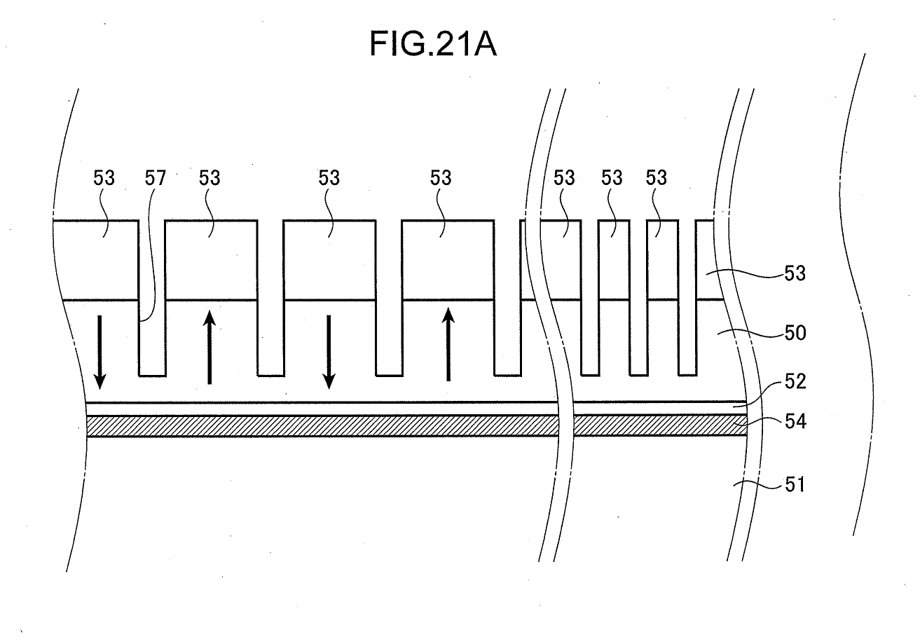

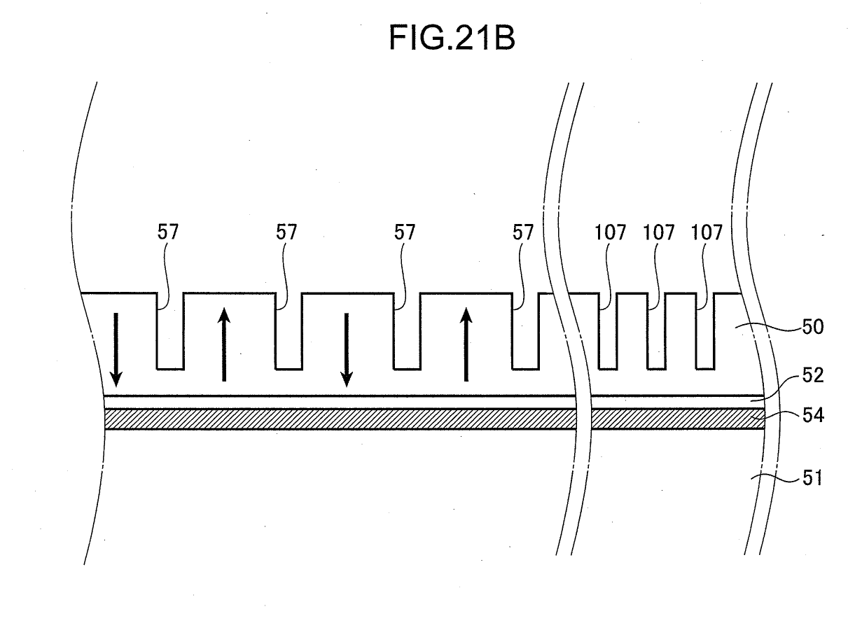

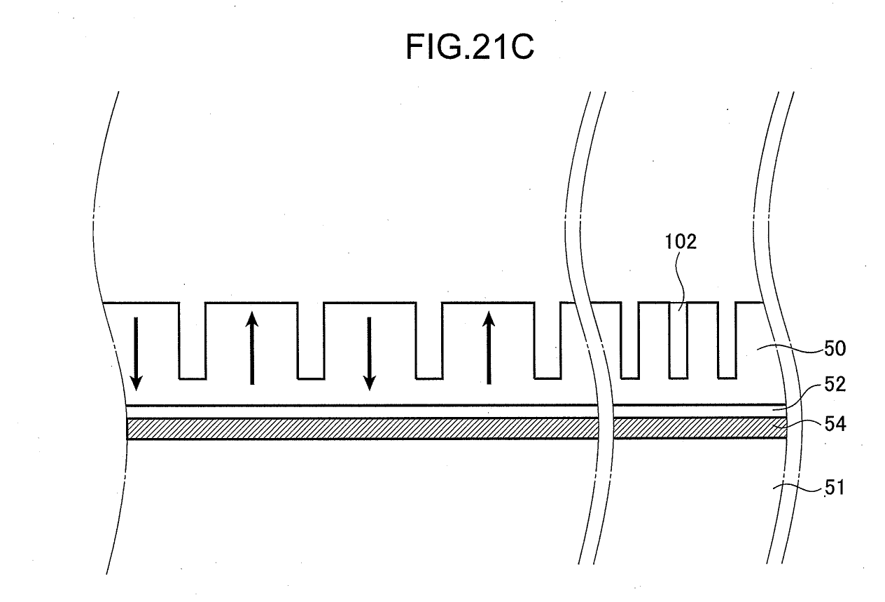

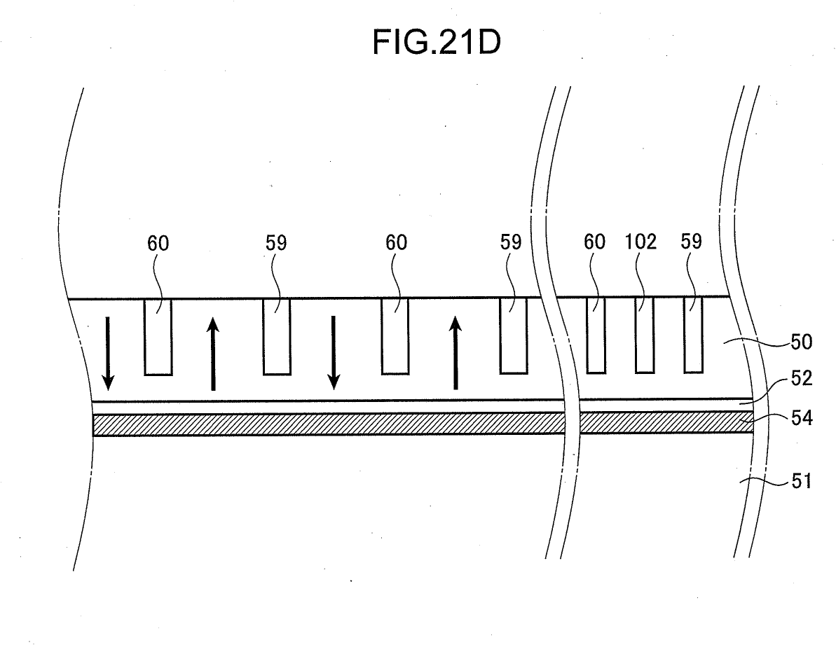

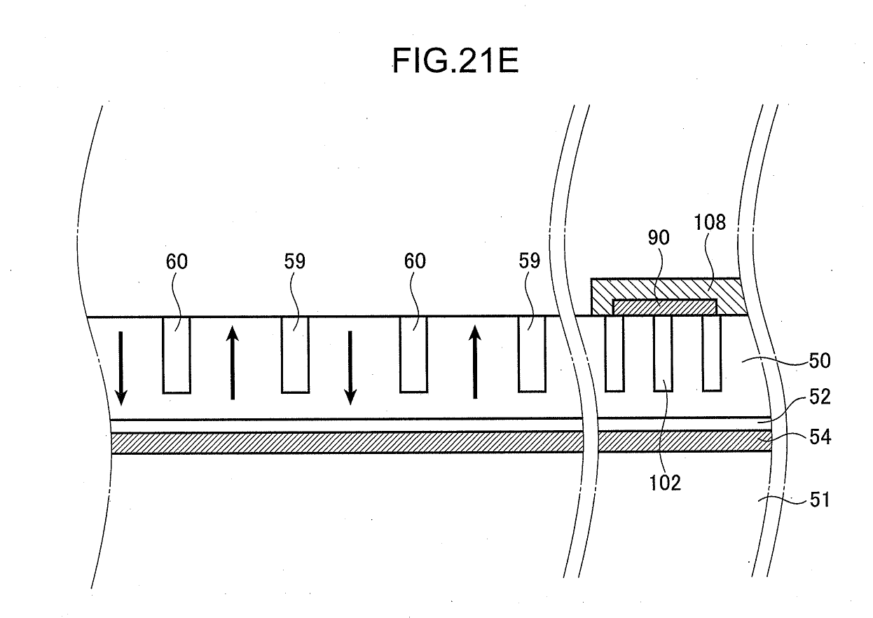

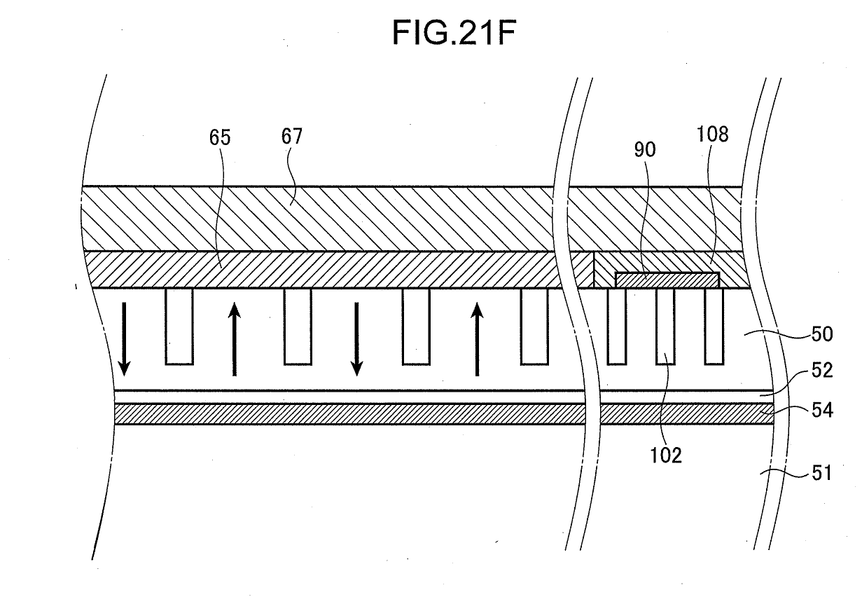

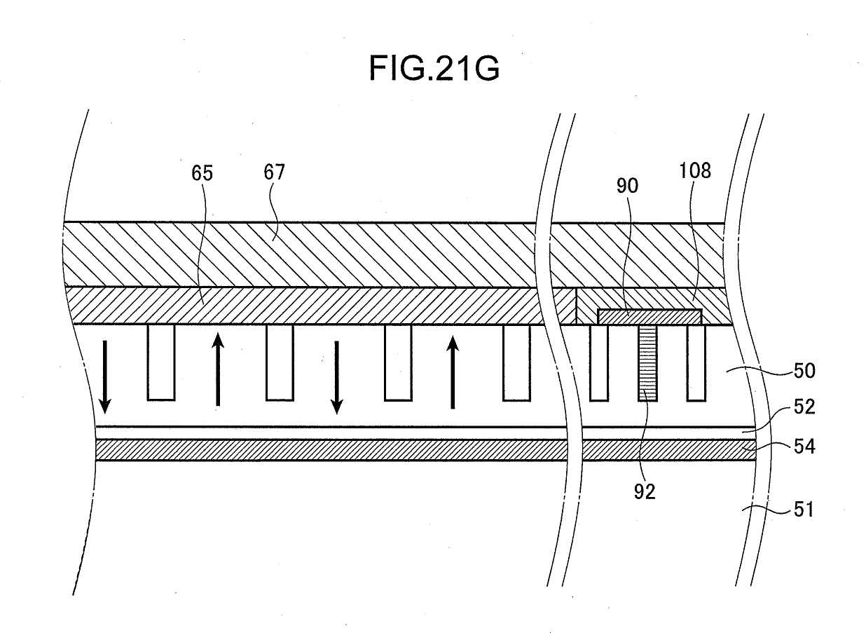

Further, Embodiment 5 will be described with reference to FIG. 20 and FIGS. 21A to 21G.

FIG. 20 is a perspective view showing a schematic structure of an actuator 33 in Embodiment 5. As shown in FIG. 20, for example, a sensor 90 for measuring displacement of the actuator 33 is provided between an electrode 42 and an electrode 46. Specifically, as shown in FIG. 20, the sensor 90 is formed, for example, in a layer the same in level as the insulating layer 35 provided on the actuator 33. Opposite ends of the sensor 90 are electrically connected to electrodes 82 and 86 respectively. The electrodes 82 and 86 are provided on the electrode 42 side and the electrode 46 side, respectively. A groove portion 92 which is internally hollow is provided in the center of the sensor.

The sensor 90 is made of a piezoelectric material having a large piezoresistance effect. That is, for example, p-type silicon doped with boron (B) or aluminum (Al) or n-type silicon doped with phosphorus (P) or arsenic (As) can be used as the piezoelectric material of the sensor 90. Beside these materials, semiconductor such as SiGe, conductive oxide such as LaSrMnO₃ or carbon nanotube can be used as the piezoelectric material.

### —Manufacturing Process—

A manufacturing process in Embodiment 5 is shown in FIGS. 21A to 21G. When the manufacturing process in Embodiment 5 is performed in the same manner as the manufacturing method shown in Embodiment 1 (or Embodiments 2 to 4), description thereof will be omitted.

Since the initial process (specifically the steps 1 to 7 in Embodiment 1) is formed in the same manner as in Embodiment 1, description of the initial process will be omitted. Step 7 and the steps following step 7 in Embodiment 1 will be described below. FIG. 21A is a view showing step 7 in Embodiment 1 (a view corresponding to FIG. 6G of Embodiment 1). That is, FIG. 21A shows the state where grooves 57 for forming electrode portions (the branch portions 45a to 45d and the branch portions 49a to 49d) are formed in the piezoelectric body layer 50. Grooves 107 for forming a groove portion 92 and electrodes 82 and 86 are formed adjacently to the grooves 57 for forming the electrode portions. Incidentally, at this stage, regions of the piezoelectric body layer 50 where the electrode portions will be formed are polarized.

### <Step 48>

Then, as shown in FIG. 21B, a resist pattern 53 is removed.

### <Step 49>

Then, as shown in FIG. 21C, a resist pattern (not shown) is formed on all regions except the groove 107 in the center. Then, SiO₂ is deposited in the groove 107 in the center by sputtering to thereby form a sacrificial layer 102.

### <Step 50>

Then, as shown in FIG. 21D, all the grooves except the groove with the sacrificial layer 102 formed therein are filled with a conducting material. Branch layers 59 and 60 for forming electrodes are formed of the conducting material.

### <Step 51>

Then, as shown in FIG. 21E, a sensor 90 is formed on the sacrificial layer 102. A sacrificial layer 108 is formed on the sensor 90 so that the sensor 90 is covered with the sacrificial layer 108. The sacrificial layer 108 is formed by deposition of SiO₂ by sputtering.

### <Step 52>

Then, as shown in FIG. 21F, an insulating material film 65 is formed in a layer the same in level as the sacrificial layer 108. Then, a head layer 67 is formed on the insulating material film 65.

### <Step 53>

Then, as shown in FIG. 21G, the sacrificial layer 102 and the sacrificial layer 108 are dissolved and removed by wet etching. Because a gap is formed around the sensor 90 in this manner, the displacement quantity of the actuator 33 can be measured accurately when the actuator 33 is displaced. Incidentally, the step of removing the sacrificial layers is performed after the substrate is separated into individual head sliders 5.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

1. A head slider comprising:
a slider substrate;
an actuator provided in an end portion of the slider substrate and equipped with a piezoelectric element; and
a magnetic head disposed on a side opposite to the slider substrate with interposition of the actuator; wherein:
the piezoelectric element has piezoelectric bodies polarized along a first direction connecting the slider substrate and the magnetic head, and electrodes which apply an electric field to the piezoelectric bodies along a second direction intersecting the first direction.

2. The head slider according to claim 1, wherein:
the second direction is a direction perpendicular to the first direction.

3. The head slider according to claim 1, wherein:
the actuator is distorted by application of the electric field to thereby move the magnetic head in the second direction.

4. The head slider according to claim 1, wherein:
the slider substrate is an AlTiC substrate containing an AlTiC material as a main material; and
an insulating film is formed between the AlTiC substrate and the actuator.

5. The head slider according to claim 1, wherein:
each of the electrodes includes a plate-like portion; and
each plate-like portion has upper and lower principal surfaces along a floating surface of the slider substrate, and a thickness decided by a distance between the upper and lower principal surfaces.

6. The head slider according to claim 5, wherein:
each plate-like portion has a taper shape decided by the upper and lower principal surfaces.

7. The head slider according to claim 1, wherein:
each of the piezoelectric bodies is disposed between adjacent electrodes; and
directions of polarization of adjacent piezoelectric bodies are reversed with respect to each other.

8. The head slider according claim 1, wherein:
each of the electrodes has a surface portion made of a conducting material, and an inner portion lower in Young's modulus of elasticity than the conducting material.

9. The head slider according to claim 1, wherein:
a underlying electrode layer for polarizing the piezoelectric bodies is provided between the electrodes and the substrate; and
a underlying insulating layer being in contact with the underlying electrode layer is provided between the underlying electrode layer and the electrodes.

10. The head slider according to claim 1, wherein:
an insulating layer for electrically insulating the actuator and the magnetic head from each other is provided between the actuator and the magnetic head; and
a sensor made of a material having a piezoresistance effect is provided in a position adjacent to the insulating layer.

11. A hard disk drive equipped with a head slider, wherein the head slider has:
a slider substrate;
an actuator provided in an end portion of the slider substrate and equipped with a piezoelectric element; and
a magnetic head disposed on a side opposite to the slider substrate with interposition of the actuator; wherein:
the piezoelectric element has piezoelectric bodies polarized along a first direction connecting the slider substrate and the magnetic head, and electrodes which apply an electric field to the piezoelectric bodies along a second direction intersecting the first direction.

12. A head slider forming method comprising:
forming a lower electrode layer, a piezoelectric body layer and an upper electrode layer successively on a substrate, the piezoelectric body layer containing a piezoelectric material as a main material;
polarizing the piezoelectric material by applying a voltage between the lower electrode layer and the upper electrode layer;
removing the upper electrode layer;
forming grooves in the piezoelectric body layer;
embedding a conducting material in the inside of each of the grooves to thereby form electrodes which apply an electric field to the piezoelectric body layer; and
forming a magnetic head.

13. The head slider forming method according to claim 12, wherein:
the direction of application of the electric field by the electrodes is perpendicular to the direction of polarization of the piezoelectric material.

14. The head slider forming method according to claim 12, further comprising:
forming local electrodes in a front surface of the polarized piezoelectric body layer after the upper electrode layer is removed; and
polarizing part of the piezoelectric body layer in a direction opposite to the polarization direction by applying a voltage between each local electrode and the lower electrode layer.

15. The head slider forming method according to claim 12, wherein:
the piezoelectric body layer has piezoelectric bodies each of which is wedged between adjacent electrodes; and
directions of polarization of adjacent piezoelectric bodies are reversed with respect to each other.

16. The head slider forming method according to claim 12, wherein:
in the step of forming the electrodes, a film of a conducting material is formed on surfaces of the grooves so that the film has recesses corresponding to the grooves, and then the recesses are filled with a material lower in Young's modulus of elasticity than the conducting material.
